(19) United States
(12) Patent Application Publication
(10) Pub. No.: US 2013/0250118 A1
(43) Pub. Date: Sep. 26, 2013

(54) IMAGE PROCESSING APPARATUS FOR CORRECTING TRAJECTORY OF MOVING OBJECT IN IMAGE

(71) Applicant: CASIO COMPUTER CO., LTD., Tokyo (JP)

(72) Inventor: Hiroki KAWAKAMI, Tokyo (JP)

(73) Assignee: CASIO COMPUTER CO., LTD., Tokyo (JP)

(21) Appl. No.: 13/845,374

(22) Filed: Mar. 18, 2013

(30) Foreign Application Priority Data
Mar. 21, 2012 (JP) 2012-064290

(51) Int. Cl. H04N 7/18

(52) U.S. Cl. CPC H04N 7/183
USPC 348/157

(57) ABSTRACT

An image processing apparatus, includes: a moving image acquisition unit which acquires a moving image captured under a first capturing situation; a trajectory correction unit which corrects a trajectory of a moving object in the moving image acquired by the moving image acquisition unit to fit the trajectory to a second capturing situation, which is different from the first capturing situation; and a display control unit which causes a display unit to display the trajectory corrected by the trajectory correction unit.

### CROSS-REFERENCE TO RELATED APPLICATIONS

This application is based upon and claims the benefit of priority from the prior Japanese Patent Application No. 2012-064290, filed on Mar. 21, 2012, the entire contents of which are incorporated herein by reference.

### BACKGROUND OF THE INVENTION

1. Field of the Invention

The present invention relates to an image processing apparatus and an image processing method which correct the trajectory of a moving object in an image and a recording medium for the same.

2. Description of Related Art

As a conventional technique, Japanese Patent Laid-open Publication No. 2003-117045 discloses a technique to capture an image of a swing in tennis, golf, baseball, or the like by a camera and check the form by looking at the captured image of the swing.

Moreover, Japanese Patent Laid-open Publication No. 11-98450 discloses a technique to facilitate such a form check by displaying the trajectory of the moving object such as a golf club.

An object of the present invention is to provide an image processing apparatus, an image processing method, and an image processing program capable of letting a user accurately understand the ideal form even in different capturing conditions.

### SUMMARY OF THE INVENTION

According to an aspect of the present invention, there is provided an image processing apparatus, including:

a moving image acquisition unit which acquires a moving image captured under a first capturing situation;

a trajectory correction unit which corrects a trajectory of a moving object in the moving image acquired by the moving image acquisition unit to fit the trajectory to a second capturing situation, which is different from the first capturing situation; and

a display control unit which causes a display unit to display the trajectory corrected by the trajectory correction unit.

According to another aspect of the present invention, there is provided an image processing method using an image processing apparatus, including:

a moving image acquisition step of acquiring a moving image captured under a first capturing situation;

a trajectory correction step of correcting a trajectory of a moving object in the moving image acquired by the moving image acquisition step to fit the trajectory to a second capturing situation, which is different from the first capturing situation; and

a display control step of displaying the trajectory corrected by the trajectory correction step.

According to still another aspect of the present invention, there is provided a recording medium storing computer readable programs which make a computer to function as:

a moving image acquisition unit which acquires a moving image captured under a first capturing situation;

a trajectory correction unit which corrects a trajectory of a moving object in the moving image acquired by the moving image acquisition unit to fit the trajectory to a second capturing situation, which is different from the first capturing situation; and

a display control unit, which causes a display unit to display the trajectory corrected by the trajectory correction unit.

### BRIEF DESCRIPTION OF THE DRAWINGS

FIG. 1 is a view illustrating an entire configuration of an image processing system.

FIG. 2 is a block diagram illustrating an internal configuration of an image processing apparatus.

FIG. 3 is a block diagram illustrating a functional configuration of a controller.

FIG. 4 is a flowchart for explaining a procedure to display or analyze the trajectory of a moving object.

FIG. 5 is a flowchart for explaining a data registration process.

FIG. 6 is a view for explaining a screen to specify a form-check start frame.

FIG. 7 is a view for explaining a screen to specify lines.

FIG. 8 is a view for explaining a screen to specify the position of a swinging player.

FIG. 9 is a view for explaining a screen to specify the position of a tennis racket.

FIG. 10 is a view for explaining a screen to specify a backswing start frame.

FIGS. 11A and 11B are views for explaining capturing angle calculation.

FIG. 12 is another view for explaining the capturing angle calculation.

FIG. 13 is a view for explaining a trajectory of the tennis racket.

FIG. 14 is a view for explaining a moving image of a check object.

FIGS. 15A and 15B are views for explaining trajectory correction.

FIG. 16 is another view for explaining the trajectory correction.

FIGS. 17A and 17B are charts for explaining reproduction timing of moving images.

FIG. 18 is a view for explaining a screen to diagnose the form of a target player.

FIG. 19 is view for explaining a screen to specify the form check start frame.

FIG. 20 is a view for explaining a screen to specify lines.

FIG. 21 is a view for explaining a screen to specify the position of the swinging player.

FIG. 22 is a view for explaining a screen to specify the position of a golf swing.

FIG. 23 is a view for explaining a screen to specify a backswing start frame.

FIG. 24 is a view for explaining capturing angle calculation.

FIG. 25 is another view for explaining the capturing angle calculation.

FIG. 26 is a view explaining the capturing angle calculation.

FIG. 27 is a view for explaining the capturing angle calculation.

FIG. 28 is a view for explaining trajectory correction.

FIG. 29 is another view for explaining the trajectory correction.

FIG. 30 is a view for explaining a screen to diagnose the form of a target player.

FIG. 31 is a view for explaining a screen to specify the positions of the golf club and, swinging player's shoulder.

FIG. 32 is a view for explaining the trajectory of the golf club.

### DETAILED DESCRIPTION OF THE PREFERRED EMBODIMENT

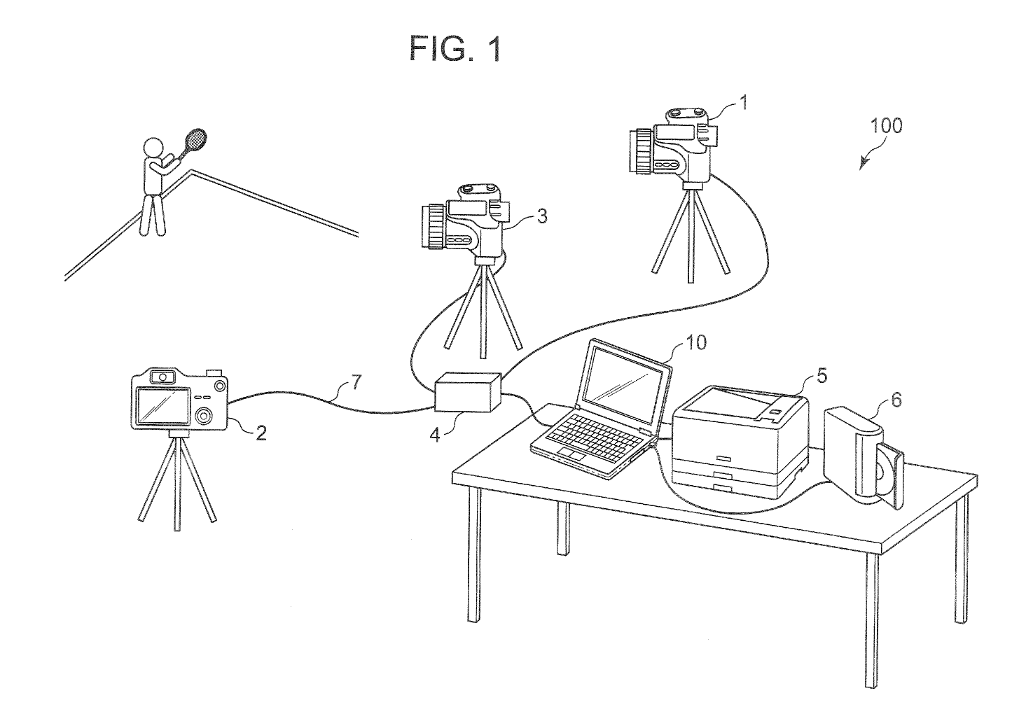

FIG. 1 shows the entire configuration of an image processing system 100 of an embodiment of the present invention.

The image processing system 100 is a system which displays or analyzes the trajectory of a moving body. In this embodiment, a description is given of a case of displaying or analyzing the trajectory of a tennis swing in a tennis court as an example. According to the embodiment, it is possible to display or analyze the trajectory of a golf swing, a baseball bat swing, or another moving body.

The image processing system 100 includes cameras 1 to 3 as a capturing unit, a HUB 4, an image processing apparatus 10, a printer 5, a medium writing unit 6, and the like, which are connected through a LAN (local area network) cable 7.

The cameras 3 are sophisticated digital cameras that capture about 30 still images per second and output moving images. The number of frames captured per second is represented in fps (frame per second). Specifically, the frame rates of the cameras 1 to 3 are 30 fps. In this embodiment, the cameras each having a frame rate of 30 fps are applied as described above, but the frame rates of the cameras are not limited to 30 fps. It is possible to apply high-speed cameras each having a frame rate of 300 to 1200 fps, for example.

The camera 1 is a camera that captures a swinging player at a first capturing angle with respect to the backline of the tennis court and outputs image data of a moving image captured at the position to the image processing apparatus 10. The camera 2 is a camera that captures the swinging player at a second capturing angle with respect to the backline of the tennis court and outputs image data of a moving image captured at the position to the image processing apparatus 10. The camera 3 is a camera that captures the swinging player at a third capturing angle with respect to the backline of the tennis court and outputs image data of a moving image captured at the position to the image processing apparatus 10.

The image processing apparatus 10 receives the image data of moving images captured with the cameras 1 to 3 and performs display, analysis, and the like for the moving image of the received image data.

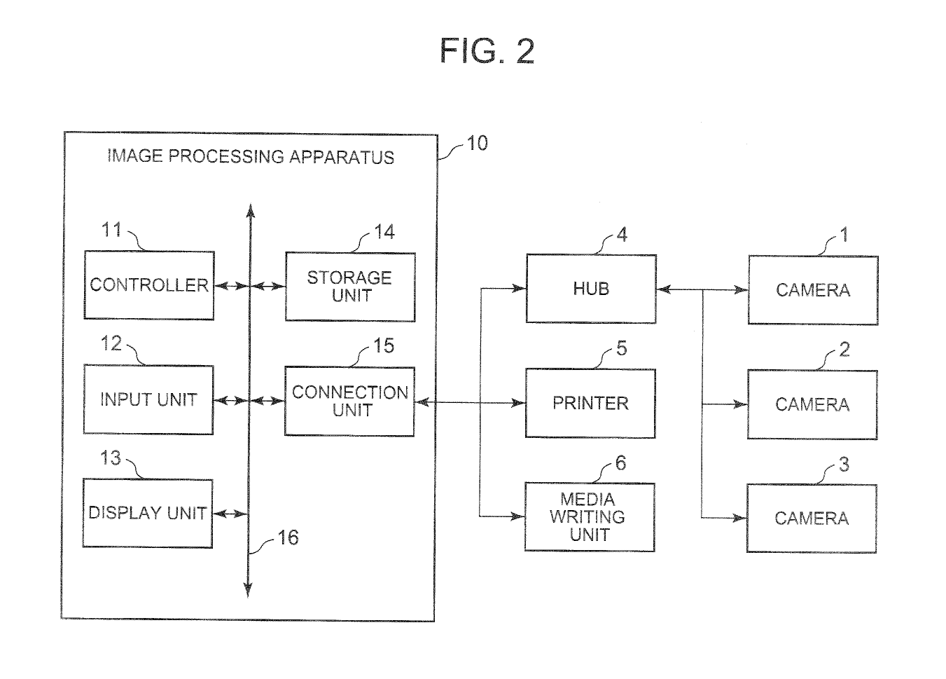

FIG. 2 shows an internal configuration of the image processing apparatus 10.

The image processing apparatus 10 includes a controller 11, an input unit 12, a display unit 13, a storage unit 14, a connection unit 15, and the like, which are connected through a bus 16. In this embodiment, the image processing apparatus 10 is composed of an information processing device such as a personal computer, for example. The functions of the image processing apparatus may be provided for the cameras 1 to 3.

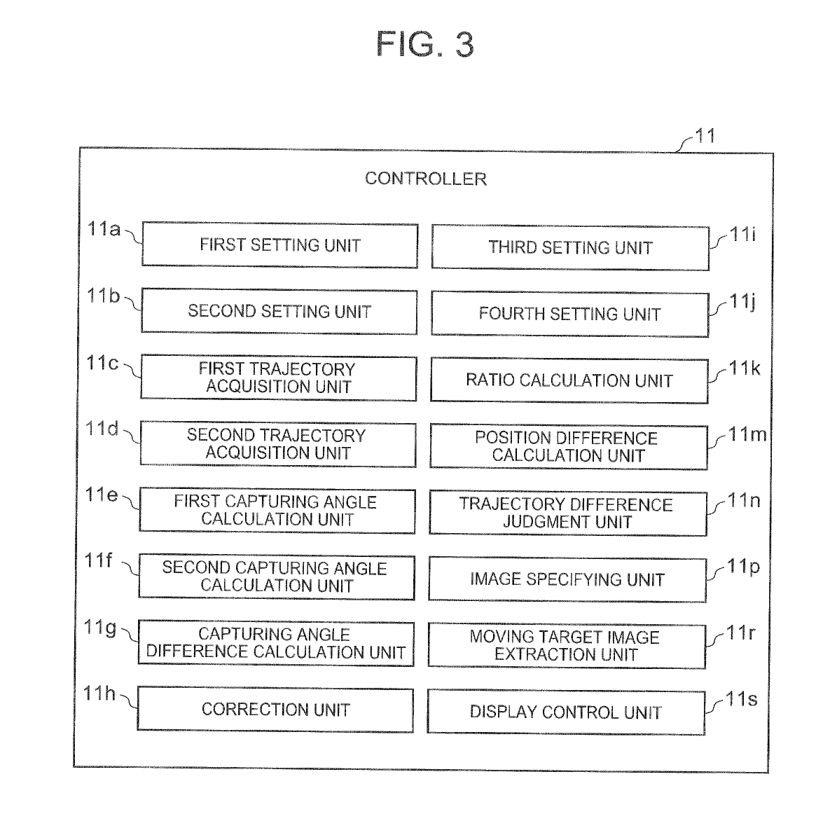

The controller 11 functioning as a trajectory correction unit includes a CPU, a RAN, and the like, which are not shown, and controls each unit of the image processing apparatus 10 in cooperation with the storage unit 14. Specifically, the controller 11 executes various programs stored in the storage unit 14 to function as a first setting unit 11a, a second setting unit 11b, a first trajectory acquisition unit 11c, a second trajectory acquisition unit 11d, a first capturing angle calculation unit 11e, a second capturing angle calculation unit 11f, a capturing angle difference calculation unit 11g, a correction unit 11h, a third setting unit 11i, a fourth setting unit 11j, a ratio calculation unit 11k, a position difference calculation unit 11m, a trajectory difference judgment unit 11n, an image specifying unit 11p, a moving target image extraction unit 11r, and a display control unit 11s as shown in FIG. 3.

The first setting unit 11a sets at least two straight lines intersecting at a first characteristic point, in a moving image acquired by capturing with each camera 1 to 3 under a first capturing situation. Specifically, the first setting unit 11a sets at least two straight lines through a user based on a moving image obtained by capturing a swing with an ideal form under a certain capturing situation, which is described in detail later. These at least two straight lines are straight lines set along the backline and sideline of a tennis court, for example. Note that a capturing situation includes a direction and/or a position in which a moving image of a series of motion of a subject is captured with a camera.

The second setting unit 11b sets at least two straight lines intersecting at a second characteristic point in a moving image obtained by capturing with each camera 1 to 3 under a second capturing situation, which is different from the first capturing situation. Specifically, the second setting unit 11b sets at least two straight lines through the user based on a moving image obtained by capturing a swing intended to be checked (a target swing) under a capturing situation different from that for the capturing of the ideal form, which is described in detail later. These at least two straight lines are straight lines set along the backline and sideline of a tennis court, for example.

The first trajectory acquisition unit us acquires a trajectory of a first moving target (a first moving object) from the moving image which is obtained by capturing with each camera under the first capturing situation as a first trajectory. Specifically, the first trajectory acquisition unit 11c acquires a trajectory of the moving target, such as a tennis racket or a golf club head, from the captured moving image of the swing with the ideal form, which is described later in detail.

The second trajectory acquisition unit 11d acquires a trajectory of a second moving target (a second moving object) from the moving image which is obtained by capturing with each camera 1 to 3 under the second capturing situation as a second trajectory. Specifically, the second trajectory acquisition unit 11d acquires a trajectory of the moving target, such as a tennis racket or a golf club head, from the captured moving image of the target swing, which is described later in detail.

The first capturing angle calculation unit 11e calculates the capturing angle of each camera 1 to 3 capturing under the first capturing situation based on the angle formed by the at least two straight lines set by the first setting unit 11a. The first capturing angle calculation unit 11e calculates the capturing angle of each camera 1 to 3 with respect to a certain position based on the angle formed by the at least two straight lines set in the moving image obtained by capturing of the swing with the ideal form, which is described in detail later.

The second capturing angle calculation unit 11.f calculates the capturing angle, of each camera 1 to 3 capturing under the second capturing situation based on the angle formed by the at least two straight lines set by the second setting unit 11a. The second capturing angle calculation unit 11f calculates the capturing angles of the cameras 1 to 3 with respect, to a certain position based on the angle formed by the at least two straight lines set in the moving image obtained by capturing of the target swing, which is described in detail later.

The capturing angle difference calculation unit 11g calculates the difference between the capturing angle calculated by the first capturing angle calculation unit 11e and the capturing angle calculated by the second capturing angle calculation unit 11f.

The correction unit 11h corrects the position of the first trajectory acquired by the first trajectory acquisition unit 11c based on the difference in capturing angle calculated by the first capturing angle calculation unit 11e. The correction unit 11h corrects the position of the trajectory of the moving target such as a tennis racket or a golf club head obtained from the captured moving image of the swing with the ideal form, based on the difference between the capturing angle of each camera 1 to 3 at the capturing under the first showing situation and the capturing angle of each camera 1 to 3 at the capturing under the second capturing situation, which is described in detail later.

The third setting unit iii sets a straight line as a third characteristic point in the moving image obtained by capturing with each camera 1 to 3 under the first capturing situation. The third setting unit 11i sets a straight, line, which is different from the strait lines at the first characteristic point, through the user based on the moving image obtained by capturing of the swing with the ideal form, which is described in detail later. This straight line is set along the central line of the body of the swinging player who is swinging with the ideal form, for example.

The fourth setting unit 11j sets a straight line as a fourth characteristic point in the moving image obtained, by capturing with each camera 1 to 3 under the second capturing situation. The fourth setting unit 11j sets a straight line, which is different from the strait lines at the second characteristic point, through the user based on the moving image obtained by capturing of the target swing, which is described in detail later. This straight line is set along the central line of the body of the swinging player who is performing a target swing, for example.

The ratio calculation unit ilk calculates the ratio of the length of the straight line set by the third setting unit iii to the length of the straight line set by the fourth setting unit 11j.

The position difference calculation unit 11m calculates the difference in position between the straight line set by the third setting unit iii and the straight line set by the fourth setting unit 11j. In other words, the position difference calculation unit 11m calculates the amount of the gap between the position of the straight line as the third characteristic point and the position of the straight line as the fourth characteristic point.

The trajectory difference judgment unit 11n judges the difference between the first trajectory corrected by the correction unit 11h and the second trajectory acquired by the second trajectory acquisition unit 11d. The trajectory difference judgment unit 11n determines how much the trajectory of the moving target, such as a tennis racket or a golf club head, which is acquired from the captured moving image of the target swing is deviated from the trajectory of the moving target, such as a tennis racket or a golf club head, which is acquired from the moving image of the swing with the ideal form with the position corrected, which is described in detail later.

The image specifying unit 11p specifies an image of the first moving target. In order to specify the moving target, the image specifying unit 11p specifies an image corresponding to the moving target through the user, which is described in detail later.

The moving target image extraction unit 11r extracts an image corresponding to the image specified by the image specifying unit 11p from the moving image obtained by capturing with each camera 1 to 3 under the first capturing situation. The moving target image extraction unit 11r performs template matching using the image specified by the user as a template, which is described later in detail. The moving target image extraction unit 11r thus extracts an image corresponding to the template from each still image constituting the moving image acquired by capturing of the swing with the ideal form.

The display controller his performs display control of the display unit 13.

The input unit 12 includes a keyboard having cursor keys and various function keys, a mouse, and the like and outputs operation signals to the controller 11.

The display unit 13 includes an LCD (liquid crystal display), an organic EL (electro-luminescence) display, and the like and performs screen display according to display signals from the controller 11.

The storage unit 14 includes an HDD (hard disk driver) and stores various programs and various types of data.

The connection unit 15 includes a bus interface such as USB (universal serial bus). The connection unit 15 receives image data of moving images outputted from the cameras 1 to 3 and outputs image data of moving images or still images to the printer 5 or medium writing unit 6.

Back in FIG. 1, the HUB 4 is a line concentrator interposed between the cameras 1 to 3 and the image processing apparatus 10 and connects the same.

The printer 5 performs a printing process for a print medium (for example, paper) according to an printing instruction from the image processing apparatus 10. The printer 5 is composed of a printing apparatus such as a page printer, for example.

The medium writing unit 6 is a device that writes digital image data of moving images into a medium (a portable recording medium) such as a DVD according to a write instruction from the image processing apparatus 10. The medium writing unit 6 may be incorporated in the image processing apparatus 10.

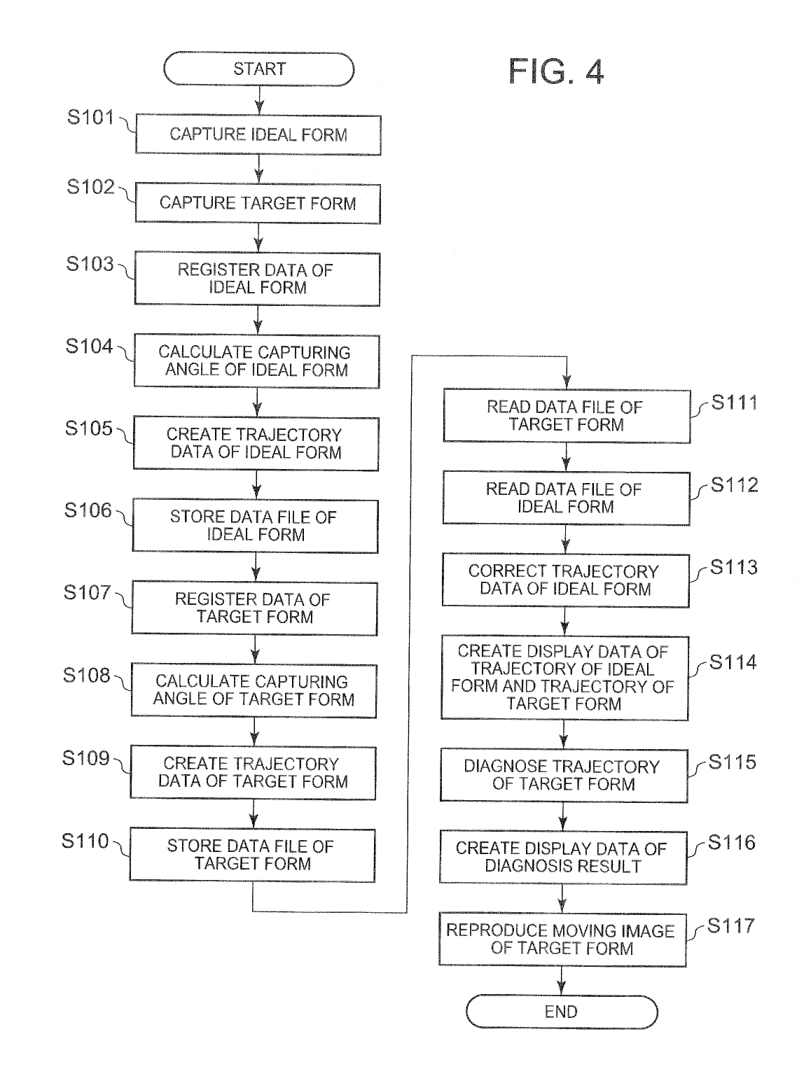

Next, with reference to FIG. 4, a description is given of a procedure to display or analyze the trajectory of a moving object using the image processing system 100 configured as described above.

In the following description, it is assumed that a swinging player in the process of a tennis swing is captured with the cameras 1 to 3 at the same time and image data of captured moving images in respective directions is stored by the image processing apparatus 10.

At first, under a certain capturing situation (the first capturing situation), a swing with a model form (the ideal form), such as a swing by an instructor or a professional player, for example, is captured with the cameras 1 to 3. The number of cameras used in the capturing is not limited to three and may be one or may be two or more. The image data of the captured moving image (moving image data of the ideal form) is stored in the storage unit 14, for example, by control of the controller 11 of the image processing apparatus 10 (step S101).

Next, a swing whose form is wanted to be checked is captured with the cameras 1 to 3 at the capturing positions different from those at the capturing of the swing with the ideal form (under the second capturing situation). Herein, it is not necessary to use all of the cameras 1 to 3. The image data of the captured moving image (moving image data of the check target) is stored by the control of the controller 11 of the image processing apparatus 10 in the storage unit 14, for example (step S102).

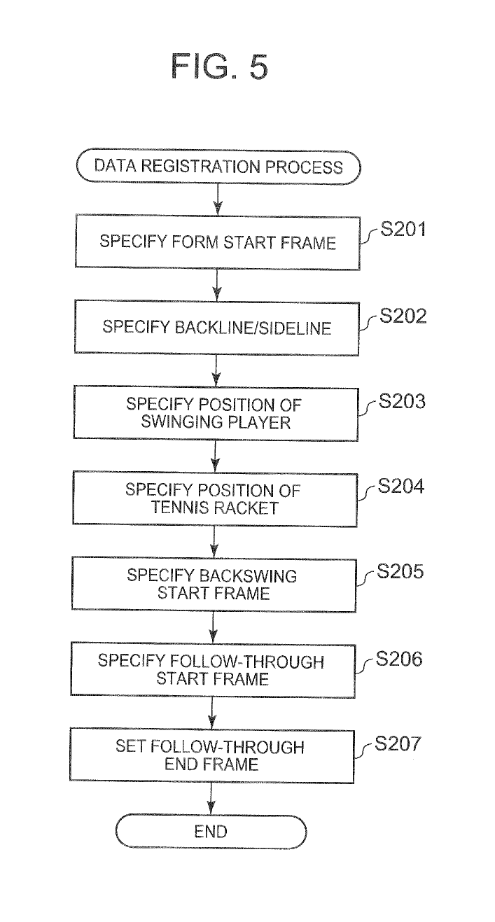

Next, the controller 11 reads the moving image data of the ideal form from the storage unit 14 and registers various data to acquire the trajectory of a tennis racket as the moving target (step S103) Herein, with reference to FIG. 5, a description is given of the procedure of a data registration process to acquire the trajectory of the tennis racket. In the following description, registration of various data is performed using moving image data with the ideal form. However, registration of various data using moving image data of the check target is performed by the same procedure.

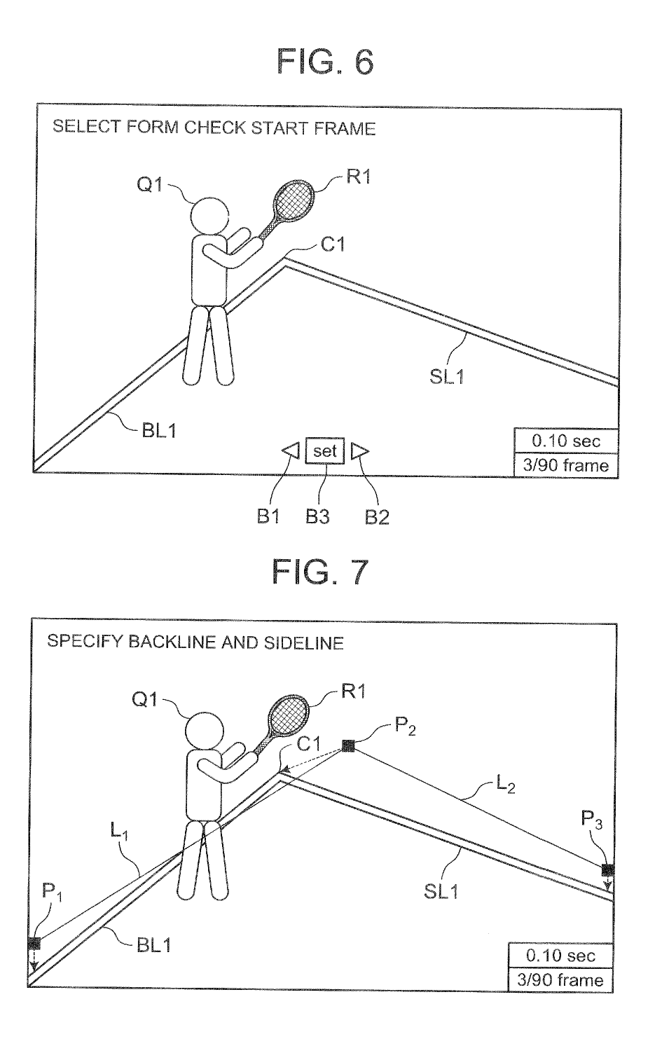

At first, the controller 11 specifies the form start frame in the read moving image data of the ideal form (step S201) In other words, the controller 11 specifies the frame with which the form diagnosis starts. More specifically, as shown in FIG. 6, for example, upon input of a selection button B1 or B2 displayed on the display screen of the display unit 13, the controller 11 sequentially displays the still images constituting the moving image with the ideal form in chronological order. FIG. 6 shows a swinging player Q1 who grips a tennis racket R1 and has a swing on the tennis court. The tennis court is surrounded by a backline BL1 and a sideline SL1 intersecting at a corner C1. The selection buttons B1 and B2 displayed on the display screen can be pressed by an operation of the mouse as the input unit 12, for example. The controller 11 specifies the form start frame upon input of a set button B3 when a still image proper as the form start frame is displayed on the display screen.

Next, the controller 11 causes the first setting unit 11a to function for specifying the backline and sideline using the still image of the specified form start frame (step S202). Specifically, for example, as shown in FIG. 7, the controller 11 defines the backline BL1 and sideline SL1 with lines L1 and L2 by move operation for the positions of pointers P1 to P3 displayed on the display screen of the display unit 13. The pointers P1 to P3 displayed on the display screen can be moved by drag operation of the mouse as the input, unit 12, for example. The positions of the pointers P1 to P3 are stored in the RAM provided for the controller 11, for example.

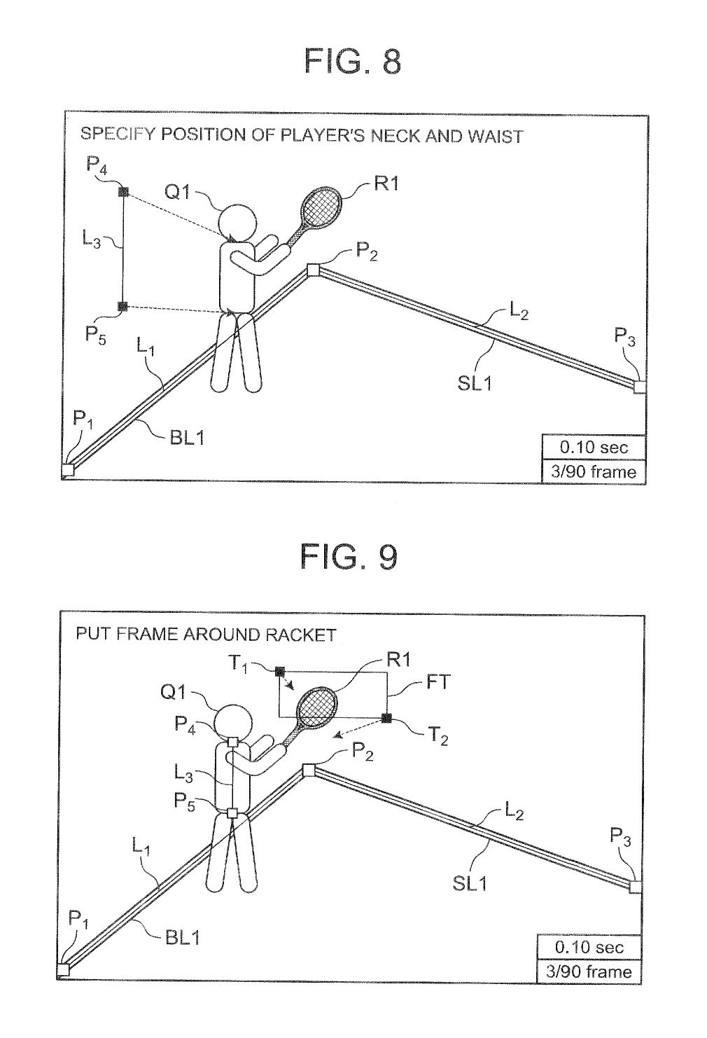

Next, the controller 11 causes the third setting unit 11i to function for specifying the position of the swinging player Q1 (step S203). Specifically, for example, as shown in FIG. 8, the controller 11 defines the position of the swinging player Q1 with a line 13 by move operation for the positions of the pointers P4 and P5 displayed on the display screen of the display unit 13. For example, the line L3 can be defined by specifying the neck and waist of the swinging player Q1 with the pointers P4 and P5, respectively. The pointers P4 and P5 displayed on the display screen can be moved by drag operation of the mouse as the input unit 12, for example. The positions of the pointers P4 to P5 are stored in the RAM provided, for the controller 11, for example.

Next, the controller 11 causes the image specifying unit 11p to function for specifying the position of the tennis racket R1 (step S204). Specifically, for example, as shown in FIG. 9, the positions of the pointers T1 and T2 displayed on the display screen of the display unit 13 are operated and moved, and the controller 11 defines a rectangular frame FT with the positions of the pointers T1 and T2. The tennis racket R1 can be specified by defining upper left part and lower right part of the tennis racket R1 with the pointers T1 and T2, for example. The pointers T1 and T2 displayed on the display screen can be moved by drag operation of the mouse as the input unit 12, for example. The positions of the pointers T1 and T2 are stored in the RAM provided for the controller 11, for example.

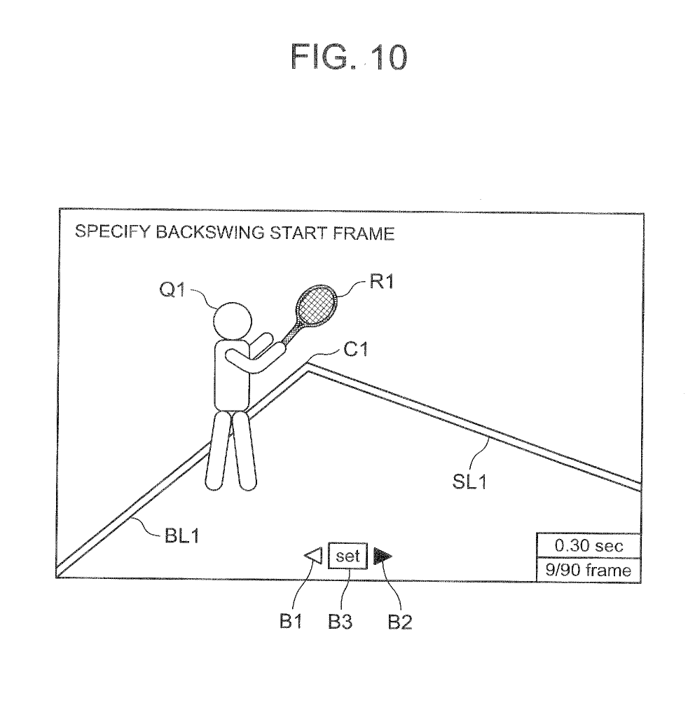

Next, the controller 11 specifies a backswing start frame in the moving image data of the ideal form (step S205) Specifically, the controller 11 specifies a frame corresponding to the start of the backswing action. More specifically, as shown in FIG. 10, for example, upon input of the selection button. B1 or B2 displayed on the display screen of the display unit 13, the controller 11 sequentially displays the still images constituting the moving image of the ideal form displayed on the screen in chronological order. The controller 11 specifies the backswing start frame upon input of the set button 83 when a still image proper as the backswing start frame is displayed on the display screen.

Next, the controller 11 specifies a follow-through start frame in the moving image data of the ideal form (step S206) Specifically, the controller 11 specifies a frame corresponding to the start of follow-through action. More specifically, upon input of the selection button B1 or B2 displayed on the display screen of the display unit 13, the controller 11 sequentially displays the still images constituting the moving image of the ideal form displayed on the screen in chronological order. The controller 11 specifies the follow-through start frame upon input of the set button B3 when a still image proper as the follow-through start frame is displayed on the display screen.

Next, the controller 11 specifies the follow-through end frame in the moving image data of the ideal form (step S207) Specifically, the controller 11 specifies a frame corresponding to the end of the follow-through action. More specifically, upon input of the selection button B1 or B2 displayed on the display screen of the display unit 13, the controller 11 sequentially changes and displays each still image constituting the moving image of the ideal form displayed on the screen in chronological order. The controller 11 specifies the follow-through end frame upon input, of the set button B3 when a still image proper as the follow-through end frame is displayed on the display screen.

When the data registration of the ideal form is finished in the above-described manner, as shown in FIG. 4, the controller 11 causes the first capturing angle calculation unit 11e to function for calculating the capturing angle with respect to the backline of the tennis court when the swing with the ideal form is captured (the capturing angle for the ideal form) (step S104)

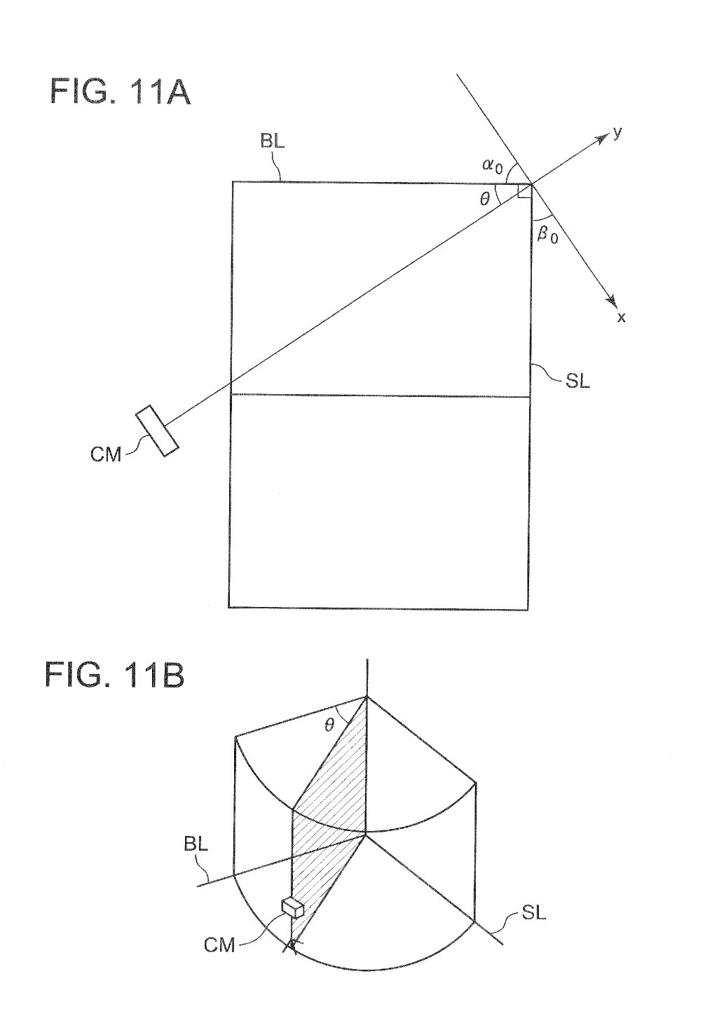

Specifically, the controller 11 calculates inclinations of the backline and sidelines, which are respectively defined by the lines L1 and L2 in FIG. 8, with respect to the horizontal line, that is, angles α and β. Herein, FIG. 11A shows a plan view of the situation of the tennis court where the swing with the ideal form is captured. FIG. 11B shows the same in a stereoscopic view. Herein, the axial line connecting a camera CM among the cameras 1 to 3 and the corner, which is the intersection of the backline BL and the sideline SL, is represented as an axis y, and the axial line which is tangent to the above corner and orthogonal to the axis y is represented by an axis x. The angle between the axis x and the backline BL is indicated by α0, and the angle between the axis x and the sideline SL is indicated by β0. At this time, the angle between the backline BL and the axis y is a capturing angle θ. In a plan view of the tennis court, the angle between the backline EL and sideline SL is 90 degrees, and the relationship of Equation 1 below is established. Herein, “a” indicates a coefficient of transformation.

(α×sin α0)²+(a×sin β0)²=1 (1)

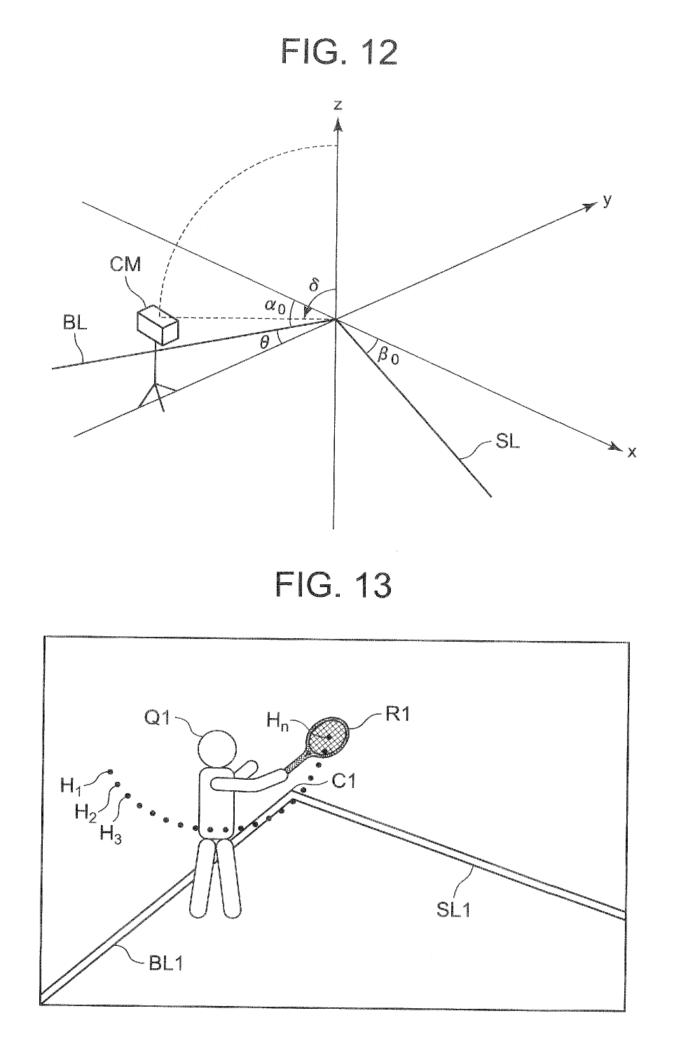

Furthermore, the above relationship is expressed on the x-y-z axes as shown in FIG. 12. The point of view is on the axis z in the plan view, and to change the point of view to an actual point of view of the camera CM, the whole system is rotated by an angle δ around the axis x as a rotation axis. Accordingly, an arbitrary point X on the x-y-z axes is rotated around the axis x into a point X′. To be specific, the coordinates of the point X′ can be calculated as shown in Equation 2 below where the coordinates of the point X are (x, y, z) and the coordinates of the point X′ are (x′, y′, z′).

$$( \begin{matrix}{x}^{′} \\ {y}^{′} \\ {z}^{′}\end{matrix} ) = ( \begin{matrix}1 & 0 & 0 \\ 0 & cos δ & sin δ \\ 0 & sin δ & sin δ\end{matrix} ) ( \begin{matrix}x \\ y \\ z\end{matrix} ) \qquad ( 2 )$$

According to Equation 2 above, it is found that the coefficient of transformation a is 1/cos δ.

When the height of the position of the corner, which is the intersection of the backline BL and sideline SL, on the axis z is set to 0, the relationships of Equations 3 and 4 below are established.

sin α=cos δ×sin α0 (3)

sin β=cos δ×sin β0 (4)

From Equations 3 and 4 above, Equation 5 below can be expressed.

(1/cos δ×sin α)2+(1/cos δ×sin β)2=1 (5)

Accordingly, the relationships of Equations 6 and 7 are established.

cos θ=1/cos δ×sin β (6)

sin θ=1/cos δ×sin α (7)

The capturing angle θ can be thus calculated. The above description is about calculation of the capturing angle θ of the one camera CM among the cameras 1 to 3, but the capturing angle θ of another camera can be calculated by the same procedure.

When the capturing angle for the ideal form is calculated as described above, the controller 11 causes the first trajectory acquisition unit 11c to function for acquiring the trajectory of the tennis racket as the moving target in the captured moving image of the swing with the ideal form (step S105). Specifically, the controller 11 causes the moving target image extraction unit 11r to function for extracting an image corresponding to the tennis racket in each of the still images constituting a part of the moving image of the swing with the ideal form between the follow-through start frame and the follow-through end frame. More specifically, the controller 11 first causes the image specifying unit 11p to function for setting the image of the tennis racket specified as described above as a template. Next, the controller 11 extracts an image matching the template image in each of the still, images constituting the part of the moving image of the swing with the ideal form between the follow-through start frame and the follow-through end frame. The controller 11 determines each of the extracted images as the image corresponding to the tennis racket and plots the centers of the extracted images as a trajectory. This provides trajectory dots H1 to Hn of the respective frames as shown in FIG. 13, for example. The method of template matching can be a publicly-known one. For example, the controller 11 sets the search range to a certain, range near the coordinates of the template image in the still image of the frame next to the frame in which the template is first set and specifies a region in which the difference in image parameter, such as RGB, is minimized, for example. The same procedure is repeated for the still images of the subsequent frames to specify a portion matching the template in each frame.

The controller 11 performs the aforementioned process for the individual moving images captured with the respective cameras 1 to 3.

Next, the moving image data of the ideal form obtained by capturing of the cameras 1 to 3 is stored as an ideal form data file, for example in the storage unit 14 together with the various data used to acquire the trajectory of the tennis racket, the capturing angles, the trajectory data of each frame, and the like, which are generated as described above (step S106). Herein, the file name of the ideal form data file is specified. The ideal form data file is created each time that the moving image data of an ideal form is created.

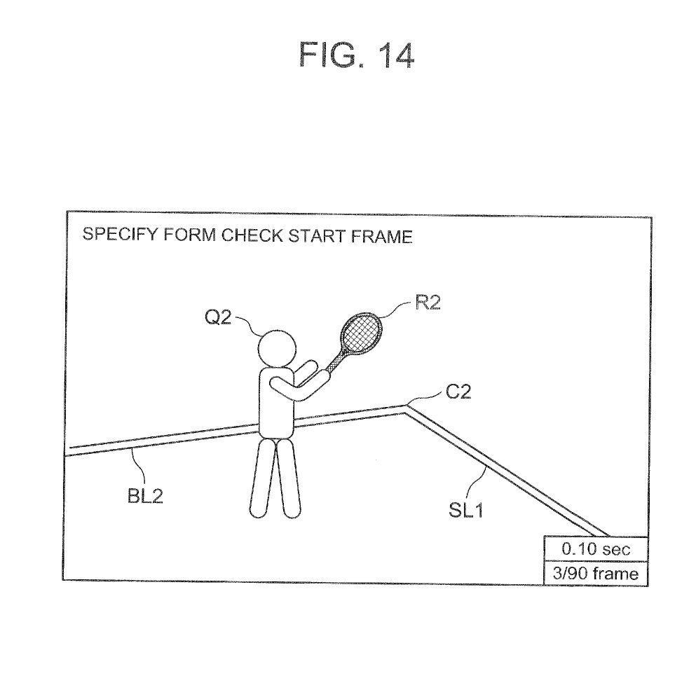

Next, the controller 11 causes the second setting unit 11b and fourth setting unit 11j to function for reading the moving image data of the check target from the storage unit 14 and registers various data to acquire the trajectory of the tennis racket as the moving target (step S107). The processing procedure to register the data to acquire the trajectory of the tennis racket is the same as the aforementioned processing procedure to register the data to acquire the trajectory of the tennis racket in the aforementioned moving image of the swing with the ideal form. Specifically, after displaying the moving image of the target swing as shown in FIG. 14 on the display screen of the display unit 13, the controller 11 specifies the form start frame, defines the backline BL2 and sideline SL2, specifies the position of a swinging player Q2, specifies the position of a tennis racket R2, specifies the backswing start frame, specifies the follow-through start frame, and specifies the follow-through end frame.

Subsequently, the controller 11 causes the second capturing angle calculation unit 11f to function for calculating the capturing angle with respect to the backline of the tennis court when the swing of the target player (the capturing angle of the target player) (step S108). The capturing angle of the target player can be calculated by the same procedure as that of the aforementioned calculation of the capturing angle for the ideal form.

Next, the controller 11 causes the second trajectory acquisition unit 11d to function for acquiring the trajectory of the tennis racket as the moving target from the captured moving image of the swing of the target player (step S109). The method of acquiring the trajectory of the tennis racket from the moving image of the swing of the target player can be performed by the same procedure as that of the aforementioned method for acquiring the trajectory of the tennis racket from the moving image of the swing with the ideal form.

Next, the controller 11 stores moving image data of the check target obtained by capturing with one of the cameras 1 to 3 or two or more of the cameras 1 to 3 as a check target form data file, for example, in the storage unit 14, together with the various data to acquire the trajectory of the tennis racket, the capturing angle, the trajectory data of each frame, and the like (step S110). The file name of the check target form data file is specified.

Thereafter, the controller 11 reads the check target form data file from the storage unit 14 (step S111) and then reads the ideal form data file from the storage unit 14 (step S112). In the process of reading the ideal form data file, the controller 11 displays a file selection screen (not shown) on the display screen of the display unit 13, for example. The user selects one from the list in the file selection screen by operating, for example, the mouse or keyboard as the input unit 12 to select an arbitrary ideal form data file.

Next, the controller 11 causes the correction unit 11b, ratio calculation unit ilk, and position difference calculation unit 11m to function for correcting the position of the trajectory of the tennis racket in the moving image of the swing with the ideal form included in the file read in the step S112 (step S113).

Herein, in the embodiment, the swing with the ideal form is captured with the cameras 1 to 3 at three capturing angles, and moving images thereof are obtained. Accordingly, it is necessary to select a moving image which is subjected to correction of the position of the trajectory data of the tennis racket. The selection of the moving image which is subjected to correction of the position of the trajectory data of the tennis racket is performed by comparing the capturing angle of each moving image obtained by capturing of the swing with the ideal form with the capturing angle of the moving image obtained by capturing of the target swing and specifying the moving image having the smallest difference in capturing angle.

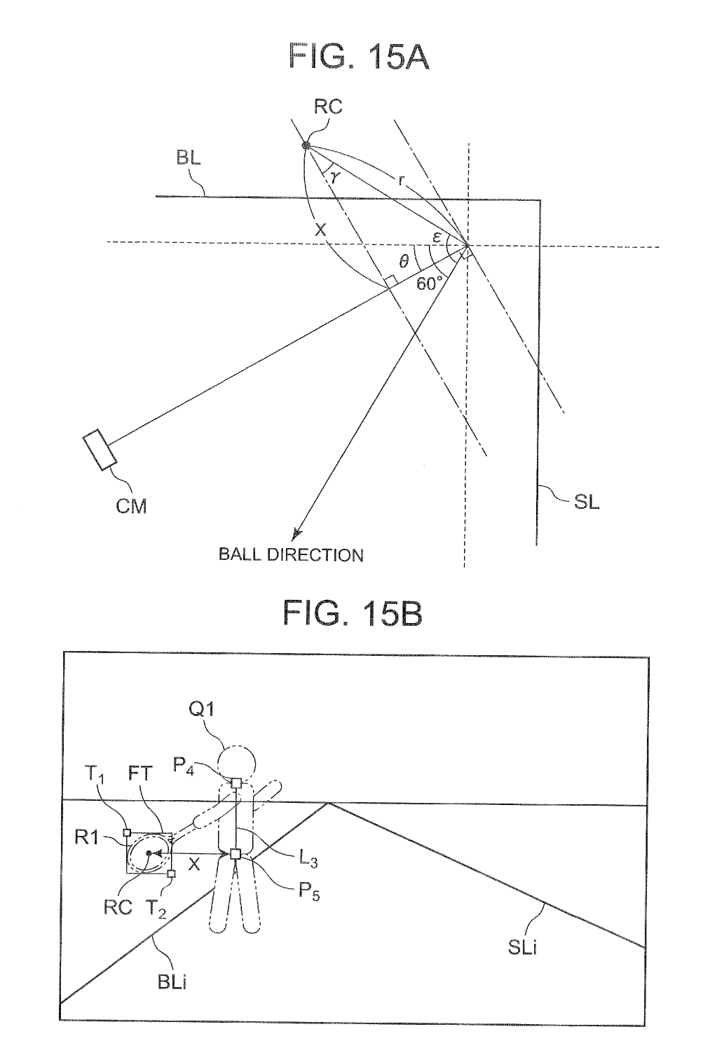

Specifically, first, in a plan view of the situation of the tennis court when the swing with the ideal form is captured, as shown in FIG. 15A, the distance between the center of the swinging player's body and the center RC of the tennis racket is indicated by a distance r, and an angle of the line connecting the center of the swinging player's body and the center RC of the tennis racket with respect to a ball's direction, which is a direction that the tennis ball goes (for example, a cross direction), is indicated by an angle ε. At this time, the angle between the backline BL and the ball's direction is about 60 degrees, for example. Moreover, the angle of the line connecting the center of the swinging player's body and the center RC of the tennis racket with respect to the line orthogonal to the axial line extended at the capturing angle θ to the backline BL is indicated by an angle γ. The distance X between the axial line which is extended through the camera CM at the capturing angle θ to the backline BL and the center RC of the tennis racket (see FIGS. 15A and 15B) in the moving image of the swing with the ideal form can be expressed Equation 8 below. Herein, “A” is a coefficient of transformation of the moving image of the swing with the ideal form to the moving image of the target swing.

X=A×r×cos γ (8)

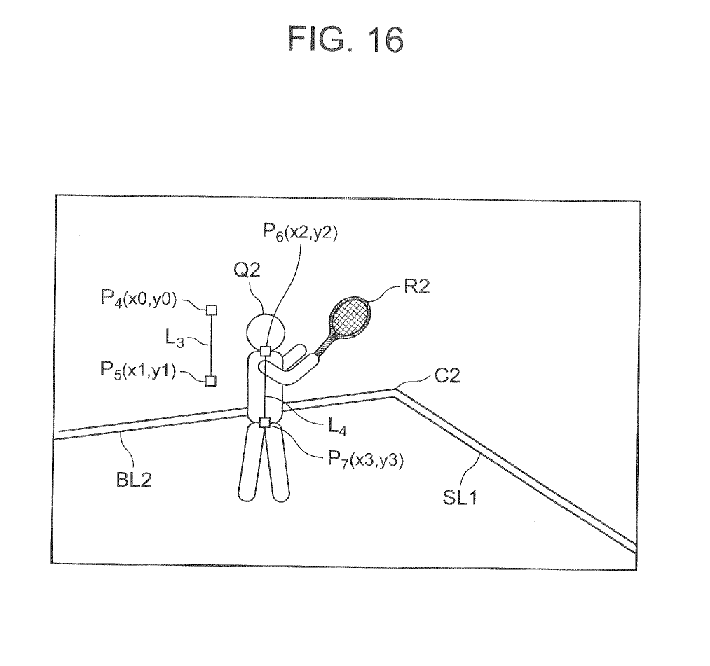

The coefficient of transformation A can be calculated from a ratio of the length of the line L4 defined in the moving image of the target swing to the length of the line L3 defined in the moving image of the swing with the ideal form as shown in FIG. 16, for example.

Herein, the angle γ can be expressed by Equation 9 below.

$$\begin{matrix}ϒ = abs ( 90 ° - ( ɛ - 60 ° + θ ) ) \\ = abs ( 150 ° - ɛ - θ )\end{matrix} \qquad ( 9 )$$

The distance X′ in the moving image of the target swing can be expressed by Equation 10 below. Herein, Δθ is a amount of gap between the capturing angle in the moving image of the swing with the ideal form and the capturing angle in the moving image of the target swing. That is to say, the distance X can be converted to the distance X′. The gap Δθ in capturing angle is calculated by the capturing angle difference calculation unit 11g caused to function by the controller 11.

$$\begin{matrix}{X}^{′} = A \times r \times cos ( γ + Δ θ ) \\ = A \times r \times cos γ \times cos Δ θ - A \times r \times sin γ \times sin Δ θ \\ = X \times cos Δ θ - A \times r \times sin γ \times sin Δ θ\end{matrix} \qquad ( 10 )$$

For example, when the gap Δθ between the capturing angle in the moving image of the swing with the ideal form and the capturing angle in the moving image of the target swing is 10 degrees, X′ is calculated by Equation 11 below.

X′=0.98×X−A×r×sin γ×0.17 (11)

Herein, the above described angle ε of the ideal from is calculated. In the moving image of the swing with the ideal form, the angle ε can be predicted, for example, based on elapsed times from the time when the backswing starts, the time when the follow-through starts, and the time when the follow-through ends, which are individually set in advance. For example, if the angle ε at the start of the backswing is 0 degrees, the angle ε is 180 degrees at the end of the backswing, that is, the start of the follow-through and is then 0 degrees at the end of the follow-through. These times can be determined by the backswing start frame, follow-through start frame, and follow-through end frame specified as described above, for example.

When the angle ε calculated, the angle γ can be calculated by Equation 9 above, and the solution of A×r×sin γ in Equation 10 above is obtained. The distance X′ can be thus calculated.

In such a manner, the trajectory dots H1 to Hn of the respective frames of the ideal form can be transformed by conversion from the distance X to the distance X′.

The controller 11 then shifts the position of the trajectory of the ideal form converted as described above so that the position of the trajectory of the ideal form fits to the position of the swinging player Q2 in the moving image of the target swing. This can provide a comparison display between the trajectory of the tennis racket of the target player in the moving image of the target swing and the trajectory of the ideal form. Specifically, the controller 11 shifts the coordinates (X1, Y1) to (Xn, Yn) of the trajectory dots H1 to Hn of the respective frames of the ideal form, which are converted as described above, into (X1′, Y1′) to (Xn′, Yn′), respectively. The corrected coordinates of the trajectory dots H1 to Hn can be calculated using Equations 12 and 13 based on the coordinates P4 (x0, y0) and P5(x1, y1) defined as described above by the functioning third setting unit 11i and the coordinates P6 (x2, y2) and P7 (x3, y3) defined by the fourth setting unit 11j caused to function as shown in the aforementioned manner in FIG. 16. Equations 12 and 13 show equations for converting the coordinates (Xn, Yn) of the trajectory dot Hn of each frame of the ideal form to the coordinates (Xn′, Yn′), but the coordinates of another trajectory dot can be calculated in a similar manner.

Xn′=(y0−y1)/(y2−y3)×Xn+(x2−x0) (12)

Yn'=(y0−y1)/(y2−y3)×Yn+(y2−y0) (13)

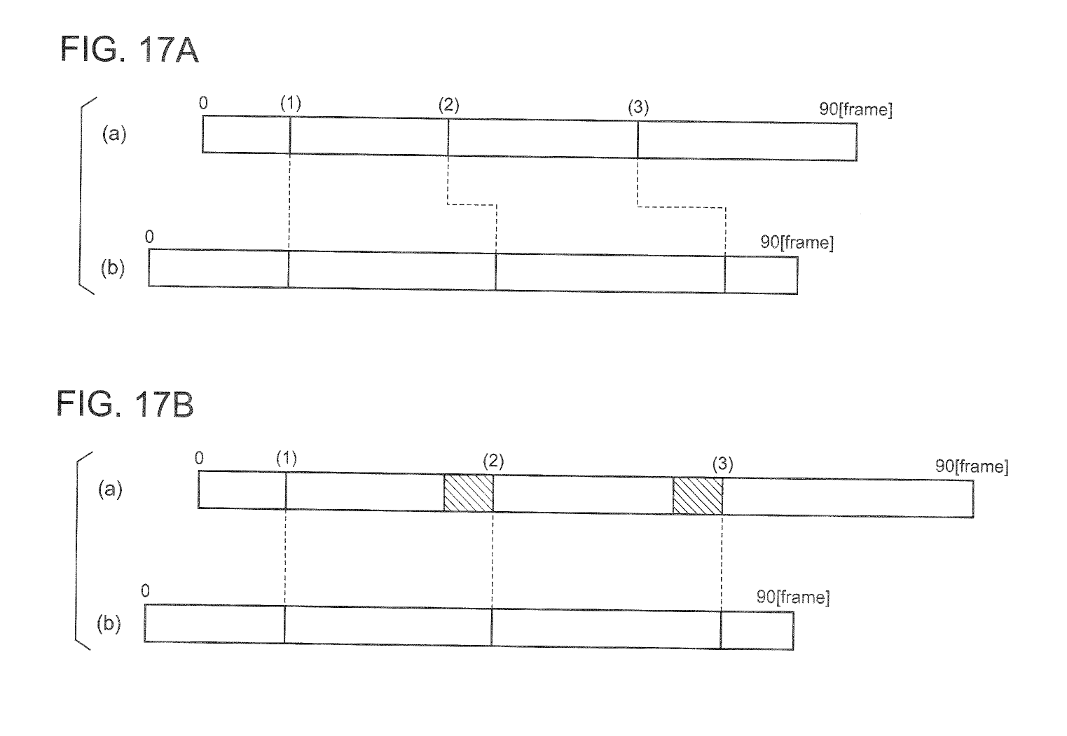

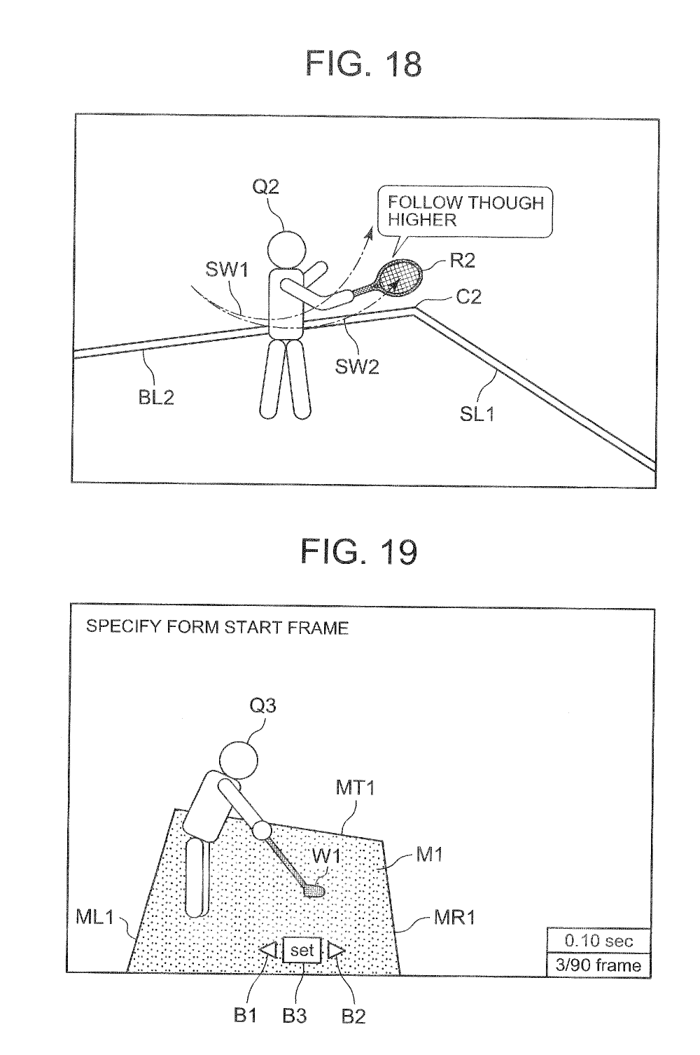

After correcting the position of the trajectory of the tennis racket in the moving image of the swing with the ideal form as described above, as shown in FIG. 4, the controller 11 creates display data to display the corrected trajectory of the tennis racket of the ideal form and the trajectory of the tennis racket of the target player (step S114). The trajectories of the frames may be displayed by dots or by a line connecting the dots. In some cases, the timing of the swing of the tennis racket differs between the moving image of the swing with the ideal form and the moving image of the target swing. Accordingly, as shown in FIG. 17A, for example, it is preferable that reproduction timing of each moving image is aligned at the backswing start frame specified as described above. When the speed of the swing with the ideal form is different from that of the swing of the check target as shown in FIG. 17A, it is possible to provide a display letting the user understand the difference in swing speed. To make the speed of the swing of the ideal form equal to that of the swing of the check target in this case, as shown in FIG. 17B, still images are added to increase the number of frames in the moving image (a) of the swing with the ideal form shown in FIG. 17A. The addition of still images can be implemented by inserting the same still images as the still images of some frames of the moving image of the swing with the ideal form. Alternatively, still images of some frames of the moving image (b) of the target swing shown in FIG. 17A may be removed. This ran let the user clearly understand the difference between the trajectory of the tennis racket with the ideal form and that of the check target. The controller 11 then causes the trajectory difference judgment unit 11n to function for judging the difference between the above trajectories and diagnosing the trajectory of the tennis racket of the check target (step S115). Specifically, the controller 11 judges whether the difference in trajectory at the start of the follow-through, the end of the follow-through, or the like exceeds a predetermined magnitude, for example. The controller 11 creates display data to display a message corresponding to the result of the diagnosis (step S116). The controller 11 performs_a display based on the display data created at the steps S114 and S116 on the display screen of the display unit 13 while displaying the moving image of the target swing (step S117). The screen shown in FIG. 18 is then displayed on the display screen of the display unit 13, for example. In FIG. 23, the difference between the corrected trajectory of the tennis racket of the ideal form and the trajectory of the tennis racket of the check target exceeds a predetermined magnitude at the end of the follow-through. Accordingly, for example, a message of “follow through higher” is displayed together with a corrected trajectory SW1 of the tennis racket with the ideal form and a trajectory SW2 of the tennis racket of the check target. The trajectories may be sequentially displayed depending on the currently displayed frame. For example, at the time when the still image of the 30th frame is displayed on the display screen of the display unit 13, the trajectory of the first to 30th frames is displayed, and the trajectory of the 31st frame and the subsequent frames is not displayed. In this embodiment, moreover, in the case of displaying the moving image of the target swing, it is possible to display still images at representative moments including the moment when the ball is hit and the moment when the swing starts. At this time, the corrected trajectory of the tennis racket of the ideal form corresponding to the displayed still image is displayed.

Next, as another example of the embodiment, a description is given of a case of displaying or analyzing a trajectory of a golf swing in a golf range using the aforementioned image processing system 100. The steps shown in the following description correspond to the respective processes in FIGS. 4 and 5 and are described with reference to FIGS. 4 and 5.

First, in a certain capturing situation (the first capturing situation), a swing with an ideal form is captured with the cameras 1 to 3 in the above described manner. Note that the number of cameras to be used for the capturing is not limited to three, and the number may be one or two or more. The captured moving image data of the ideal form is stored in the storage unit 14, for example, by control of the controller 11 of the image processing apparatus 10 (step S101)

Moreover, the swing whose form is wanted to be checked is captured with each camera 1 to 3 at the capturing position different from that in the capturing of a swing with the ideal form (under the second capturing situation). Note that the capturing camera may be either one of cameras 1 to 3. The moving image data of the check target is stored in the storage unit 14, for example, by control of the controller 11 of the image processing apparatus 10 (step S102)

Next, the controller 11 reads the moving image data of the ideal form from the storage unit 14 and registers various data to acquire a trajectory of a golf club as a moving target (step S103).

Hereinbelow, a description is given of the procedure of a data registration process to acquire a trajectory of the golf club. At first, the controller 11 specifies a form start frame in the read moving image data of the ideal form (step S201) More specifically, as shown in FIG. 19, for example, upon input of the selection button B1 or B2 displayed on the display screen of the display unit 13, the controller 11 sequentially displays the still images constituting the moving image with the ideal form in chronological order. FIG. 19 shows swinging player Q3 who grips a golf club W1 and has a swing on a mat M1. The mat M1 is surrounded by a left edge ML1, a front edge MT1, and a right edge MR1. The controller 11 specifies the form stair frame upon input, of the set button B3 when a still image proper as the form start frame is displayed on the display screen.

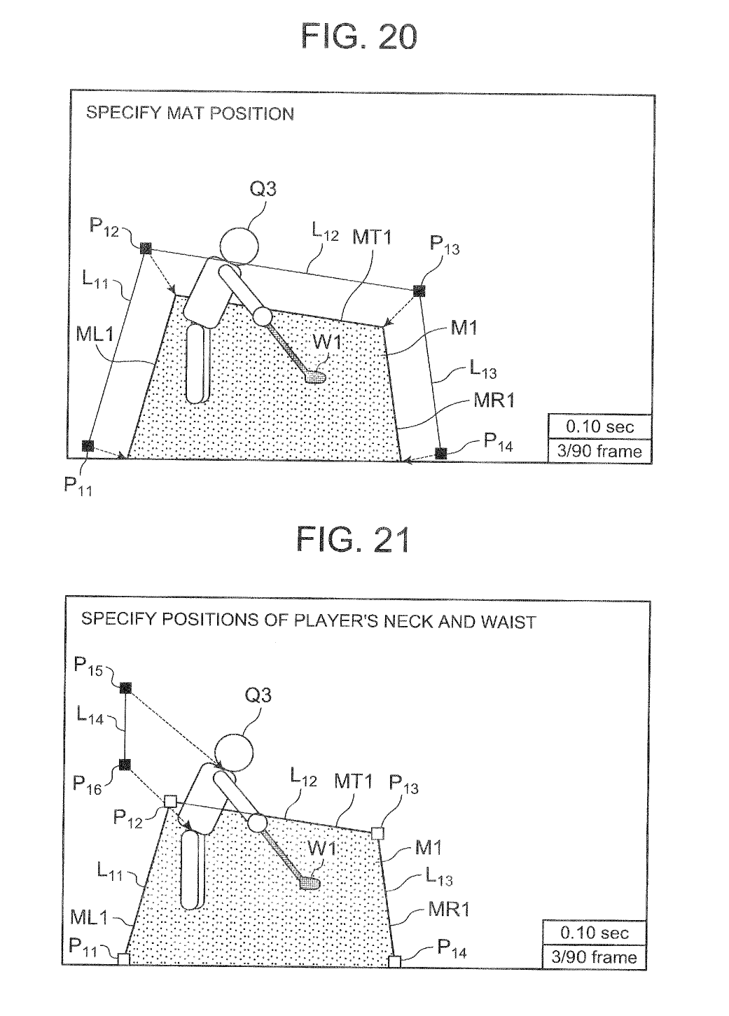

Next, the controller 11 causes the first setting unit 11a to function for specifying the left edge ML1, front edge MT1, and right edge MR1 of the mat M1 using the still image of the specified form start frame (step S202). Specifically, for example, as shown in FIG. 20, the controller 11 defines the left edge ML1, front edge MT1, and right edge MR1 of the mat M1 with lines L11 to L13 by move operation for the positions of pointers P11 to P14 displayed on the display screen of the display unit 13. In this embodiment, three points including the left edge ML1, front edge MT1, and right edge MR1 in the mat M1 are defined to increase the accuracy in calculating the capturing angle, but the capturing angle may be calculated by defining two points among the three. The positions of the pointers P11 to P14 are stored in the RAM provided for the controller 11, for example.

Next, the controller 11 causes the third setting unit 11i to function for specifying the position of the swinging player Q3 (step S203). Specifically, for example, as shown in FIG. 21, the controller 11 defines the position of the swinging player Q3 with a line L14 by move operation for the position of the pointers P15 and P16 displayed on the display screen of the display unit 13. The positions of the pointers P15 and P16 are stored in the RAM provided for the controller 11, for example.

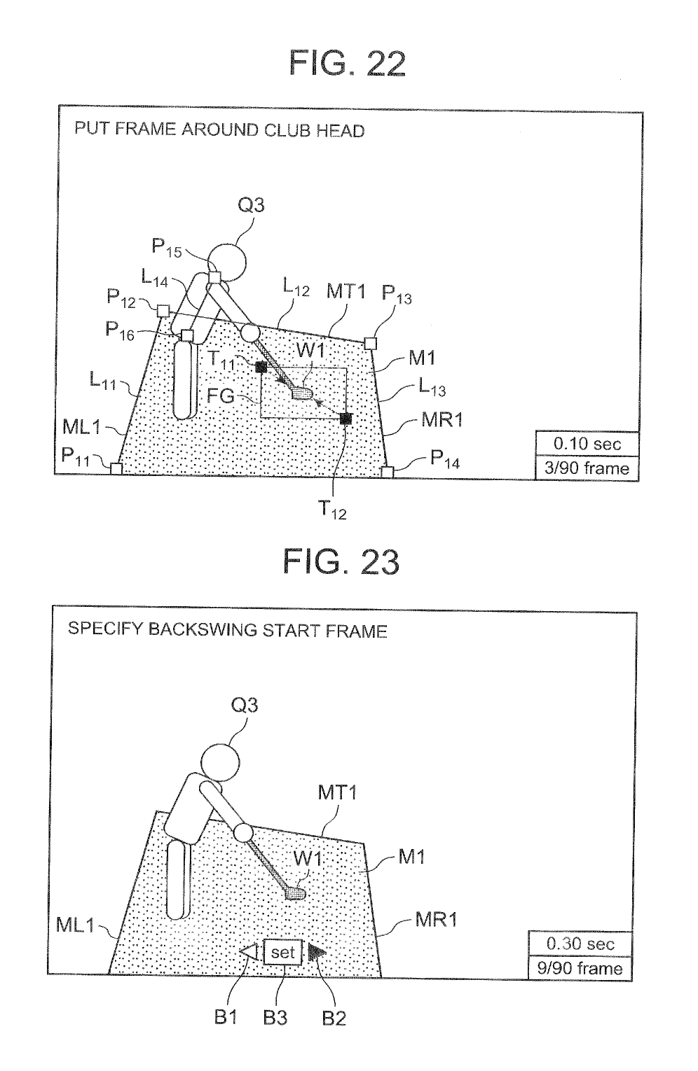

Next, the controller 11 causes the image specifying unit 11p to function for specifying the position of the golf club W1 (step S204). Specifically, for example, as shown in FIG. 22, the positions of pointers T11 and T12 displayed on the display screen of the display unit 13 are operated and moved, and the controller 11 defines a rectangular frame FG with the positions of the pointers T11 and T12. The golf club W1 can be defined by specifying upper left part and lower right part of the golf club W1 with the pointers T11 and T12, for example. The pointers T11 and T12 are stored in the RAM provided for the controller 11, for example.

Next, the controller 11 specifies a backswing start frame in the moving image data of the ideal form (step S205). Specifically, as shown in FIG. 23, for example, upon input of the selection button E1 or B2 displayed on the display screen of the display unit 13, the controller 11 sequentially displays the still images constituting the moving image of the ideal form displayed on the screen, in chronological order. The controller 11 specifies the backswing start frame upon input of the set button B3 when a still image proper as the backswing start frame is displayed on the display screen.

Next, the controller 11 specifies a follow-through start frame in the moving image data of the ideal form (step S206). More specifically, upon input of the selection button B1 or B2 displayed on the display screen of the display unit 13, the controller 11 sequentially displays the still images constituting the moving image of the ideal form displayed on the screen in chronological order. The controller 11 specifies the follow-through start frame upon input of the set button B3 when a still image proper as the follow-through start frame is displayed on the display screen.

Next, the controller 11 specifies the follow follow-through end frame in the moving image data of the ideal form (step S207). More specifically, upon input of the selection button E1 or B2 displayed on the display screen of the display unit 13, the controller 11 sequentially displays the still images constituting the moving image of the ideal form displayed on the screen in chronological order. The controller 11 specifies the follow-through end frame upon input of the set button B3 when a still image proper as the follow-through end frame is displayed on the display screen.

When the data registration of the ideal form is finished as described above, the controller 11 causes the first capturing angle calculation unit 11e to function for calculating a capturing angle of the ideal form (step S104).

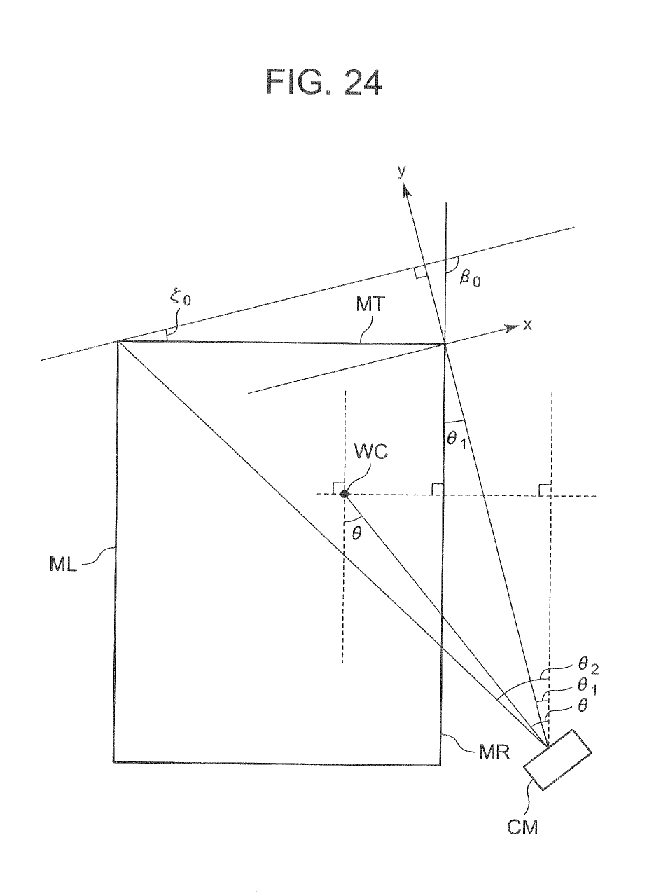

Specifically, the controller 11 calculates inclinations of the left, front, and right edges ML1, MT1, and MR1 of the mat. M1, which are respectively defined by the lines L11 to L13 in FIG. 22, with respect to the horizontal line, that is, angles α, ζ and β. FIG. 24 shows a plan view of the situation of a mat where the swing with the ideal form is captured. Herein, the axial line connecting a camera CM among the cameras 1 to 3 and the corner, which is an intersection of the front edge MT and right edge MR of the mat, is represented as an axis y, and the axial line which is orthogonal to the axis y is represented by an axis x. The angle between the axis x and the right edge MR1 is indicated by β0, and the angle between the axis x and the right edge MR1 is indicated by ζ0.

First for the intersection of the front edge MT and right edge MR of the mat, an angle θ1 of an axial line connecting the above intersection and the camera CM with respect to the right edge MR is calculated. In the plan view of the mat, the angle between the front edge MT and right edge MR of the mat is 90 degrees. With reference to FIG. 24, the angle θ1 is equal to the angle ζ0, and the relationship of Equation 14 below is therefore established. Herein, a1 indicates a coefficient of transformation.

(a1×sin β0)²+(a1×sin ζ0)²=1 (14)

The above relationship is expressed on the x-y-z axes as described above. The point of view is on the axis z in the plan view, and to change the point of view to an actual point of view of the camera CM, the whole system is rotated by an angle δ1 around the axis x as a rotation axis. As described above, therefore, the coefficient of transformational is 1/cos δ1.

When the height of the position of the corner, which is the intersection of the front edge MT and right edge MR of the mat, is set to 0 on the axis z, the relationships of Equations 15 and 16 below are established.

sin β=cos δ1×sin β0 (15)

sin ζ=cos δ1×sin ζ0 (16)

Based, on Equations 15 and 16 above, Equation 17 below can be expressed.

(1/cos δ1×sin β)2+(1/cos δ1×sin ζ)2=1 (17)

Accordingly, the relationships of Equations 18 and 19 are established.

cos θ1=1/cos δ1×sin β (18)

sin θ1=1/cos δ1×sin ζ (19)

The angle θ1 can be thus calculated.

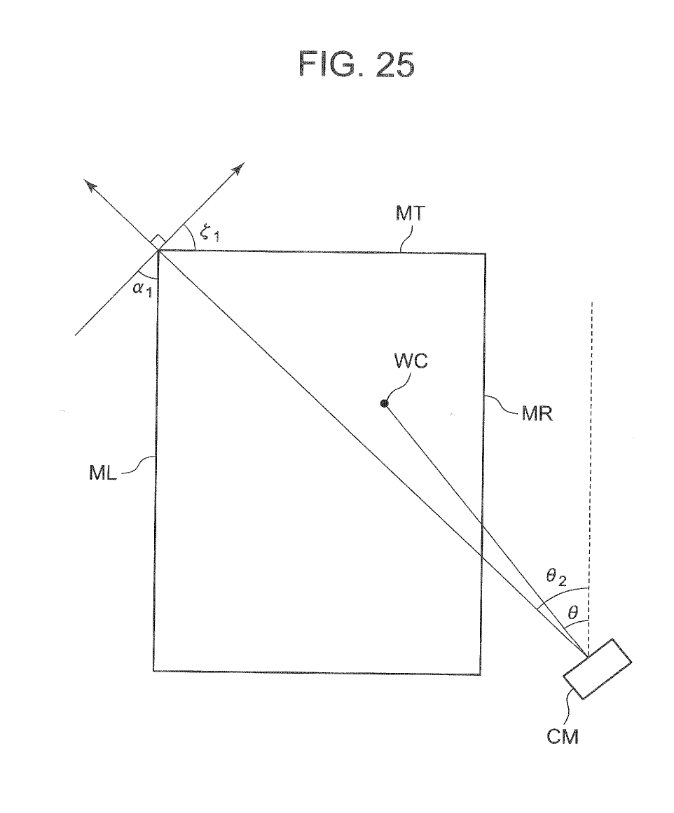

Next, with reference to FIG. 25, as for the intersection of the front edge MT and left edge ML of the mat, an angle θ2 of an axial line connecting the above intersection and the camera CM with respect to the left edge ML is calculated. In the plan view of the mat, the angle between the front edge MT and left edge ML of the mat is 90 degrees, and the relationship of Equation 20 below is established. Herein, a2 indicates a coefficient of transformation.

(a2×sin α1)2+(a2×sin ζ1)2-1 (20)

Herein, the above relationship is expressed on the x-y-z axes as described above. The point of view is on the axis z in the plan view, and to change the point of view to an actual point of view of the camera CM, the whole system is rotated by an angle 52 around the axis x as a rotation axis. The coefficient of transformation a2 is therefore 1/cos δ1 as described above.

When the height of the position of the corner, which is the intersection of the front, edge MT and left edge ML of the mat, is set to 0 on the axis z, the relationships of Equations 21 and 22 below are established.

sin α=cos δ2×sin α1 (21)

sin ζ=cos δ2×sin ζ1 (22)

Based on Equations 21 and 22 above, Equation 23 below can be expressed.

(1/cos δ2×sin α)²+(1/cos δ2×sin ζ)²=1 (23)

Accordingly, the relationships of Equations 24 and 25 are established.

cos θ2=1/cos δ2×sin α (24)

sin θ2=1/cos δ2×sin ζ (25)

The angle θ2 can be thus calculated.

Next, the capturing angle θ is calculated based on the angles θ1 and θ2.

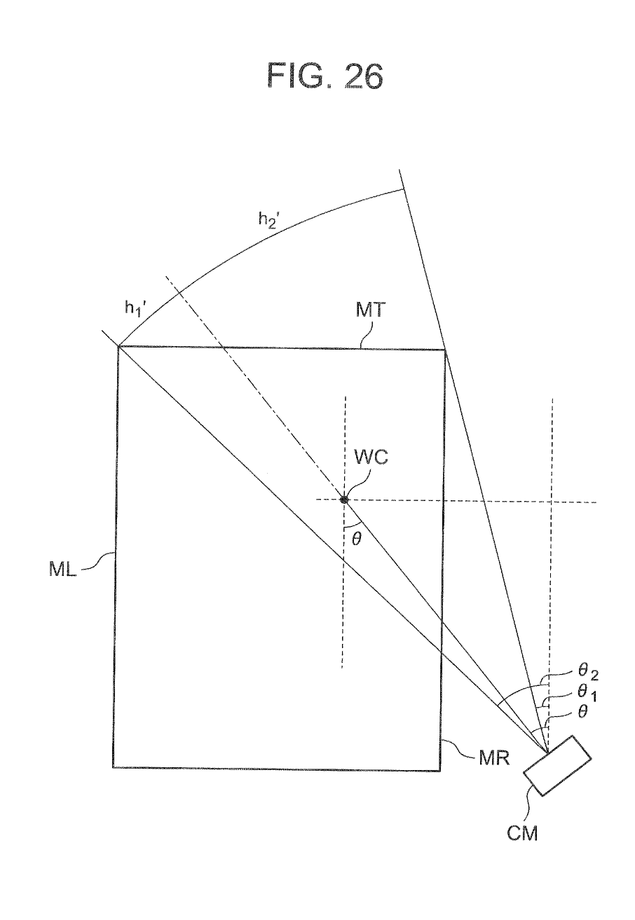

As shown in FIG. 26, in the plan view of the mat, the capturing angle θ can be expressed by Equation 26 below.

θ=h2′/(h1′+h2′)×θ1+h1′/(h1′+h2′)×2, (26)

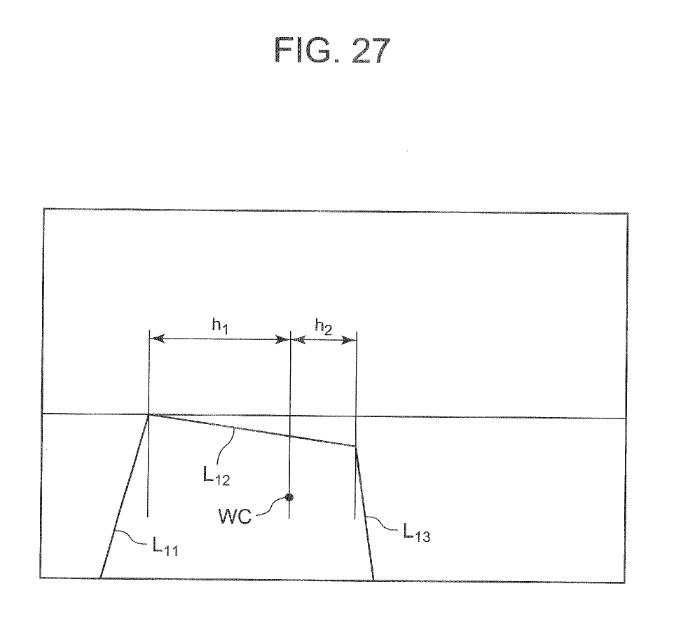

The relationship expressed by Equation 26 is substantially the same as that on the display screen. Accordingly, as shown in FIG. 27, the capturing angle θ can be calculated by Equation 27 below by calculating horizontal distance h1 between the intersection of the lines L11 and L12 and the center WC of the head of the golf club and horizontal distance h2 between the intersection of the lines L12 and L13 and the center WC of the head of the golf club. The center WC of the head of the golf club is the center of the frame FG defined by the pointers T11 and T12 as described above.

θ=h2/(h1+h2)×θ1+h1/(h1+h2)×θ2 (27)

The capturing angle θ is thus calculated. The above description is about calculation of the capturing angle θ of the camera CM among the cameras 1 to 3, but the capturing angle θ of another camera can be calculated in a similar procedure.

When the capturing angle of the ideal form is calculated as described above, the controller 11 causes the first trajectory acquisition unit 11c to function for acquiring the trajectory of the golf club as the moving target in the moving image of the swing with the ideal form (step S105). Specifically, the controller 11 causes the moving target image extraction unit 11r to function for extracting an image corresponding to the golf club in each of the still images constituting a part of the moving image of the swing with the ideal form between the follow-through start frame and the follow-through end frame. The controller 11 first causes the image specifying unit 11p to function for setting the image of the head of the golf club specified as described above as a template. Next, the controller 11 extracts an image matching the template image in each of the still images constituting the part of the moving image of the swing with the ideal form between the follow-through start frame and the follow-through end frame. The controller 11 determines each extracted image as the image of the head of the golf club and plots the centers of the extracted images as a trajectory. The trajectory elements of the respective frames can be thus obtained in the same way as that in the above description.

The controller 11 performs the aforementioned process for each of the moving images obtained by capturing with the cameras 1 to 3.

Next, the moving image data of the ideal form obtained by capturing with the cameras 1 to 3 is stored as an ideal form data file in the storage unit 14, for example, together with the various data to acquire the trajectory of the golf club, the capturing angle, the trajectory data of each frame, and the like, which are created as described above (step S106). Herein, the file name of the ideal form data file is specified. The ideal form data file is created each time that the moving image data of the ideal form is created.

Next, the controller 11 causes the second setting unit 11b and fourth setting unit 11j to function for reading the moving image data of the check target from the storage unit 14 and registering the various data to acquire the trajectory of the golf club as a moving target (step S107). The processing procedure to register the data to acquire the trajectory of the golf club is the same as the aforementioned processing procedure to register the data to acquire the trajectory of the golf club in the above-described moving image of the swing with the ideal form.

Subsequently, the controller 11 causes the second capturing angle calculation unit 11f for calculating the capturing angle when the swing of the target player is captured (the capturing angle of the target player) (step S108). The capturing angle of the target player can be calculated by the same procedure as that of the aforementioned, calculation of the capturing angle of the ideal form.

Next, the controller 11 causes the second trajectory acquisition unit 11d to function for acquiring the trajectory of the golf club as the moving target from the moving image of the swing of the target player (step S109). The method of acquiring the trajectory of the golf club from the moving image of the swing of the target player can be performed by the same procedure as that of the aforementioned method for acquiring the trajectory of the golf club from the moving image of the swing with the ideal form.

Next, the controller 11 stores moving image data of the check target obtained by capturing with one of the cameras 1 to 3 or two or more thereof as a check target form data file in the storage unit 14, for example, together with the various data to acquire the trajectory of the golf club, the capturing angle, the trajectory data of each frame, and the like, which are created as described above (step S110). The file name of the check target form data file is specified.

Thereafter, the controller 11 reads the check target form data file from the storage unit 14 (step S111) and then reads the ideal form data file from the storage unit 14 (step S112). The ideal form data file is read by the above-described manner.

Next, the controller 11 causes the correction unit 11b, ratio calculation unit 11k, and position difference calculation unit 11m to function for correcting the position of the trajectory data of the golf club in the moving image of the swing with the ideal form which is included in the file read in the step S112 (step S113). The moving image which is subjected to correction of the position of the trajectory data of the golf club is selected by the above-described manner.

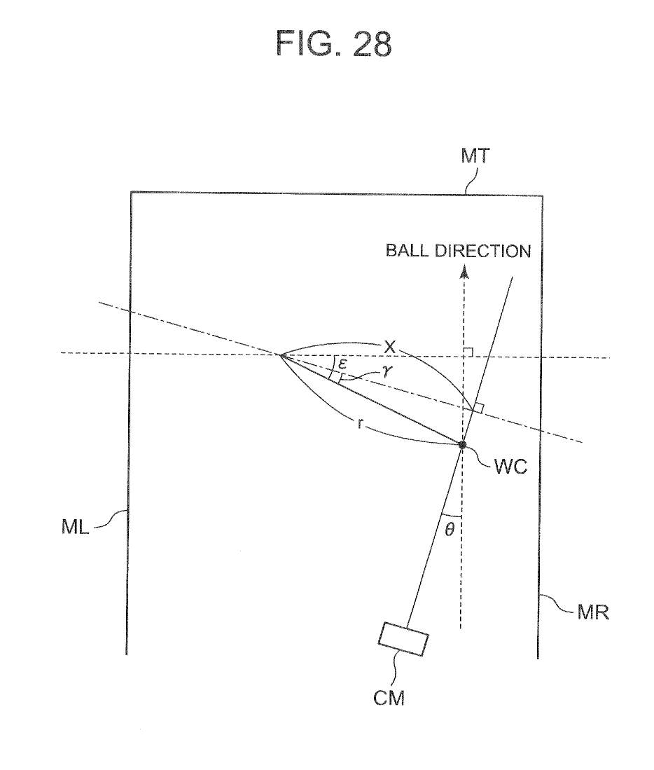

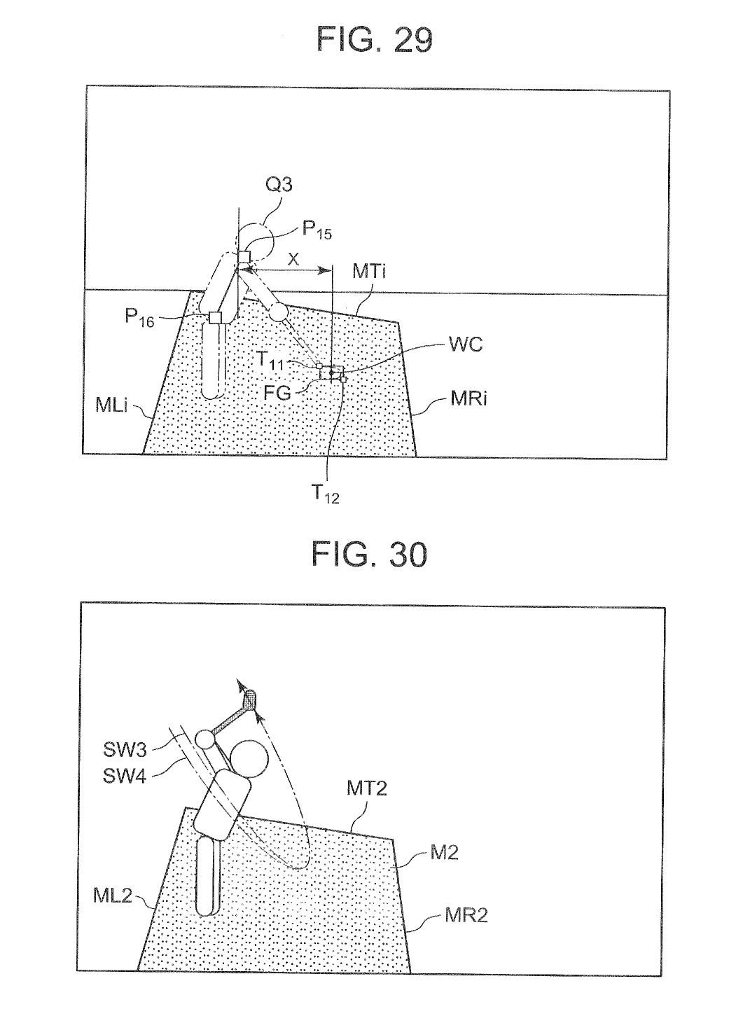

Specifically, first, in a plan view of the situation of the mat of the golf range where the swing with the ideal form is captured, as shown in FIG. 28, the distance between the center of the swinging player's body and the center WC of the head of the golf club is represented by a distance r, and an angle of a line connecting the center of the swinging player's body and the center WC of the head of the golf club with respect to the direction, orthogonal to the ball's direction is represented by an angle ε. Moreover, the angle of the line connecting the center of the swinging player's body and the center WC of the head of the golf club with respect to the line orthogonal to the axial line extended at the capturing angle θ to the right edge MR of the mat is indicated by an angle γ. A distance between the axial line which is extended through the camera CM at the capturing angle θ to the right edge MR of the mat and the center WC of the head of the golf club (see FIGS. 28 and 29) in the moving image of the swing of the target player is expressed by Equation 8 above in the same way.

The coefficient of transformation A can be calculated based on a ratio of the length of the line defined in the moving image of the target swing to the length of the line defined in the moving image of the swing with the ideal form as described above.

Herein, the angle γ can be expressed by Equation 28 below

γ=ε−θ (28)

The distance X′ in the moving image of the target swing can be expressed by Equation 10 above. Herein, Δθ is a amount of gap between the capturing angle in the moving image of the swing with the ideal form and the capturing angle in the moving image of the swing of the target player. The gap Δθ in capturing angle can be calculated by the capturing angle difference calculation unit 11g caused to function by the controller 11.

Herein, the above described angle ε of the ideal from is calculated in the above described manner. For example, if the angle ε at the start of the backswing is 0 degrees, the angle ε is 180 degrees at the start of the follow-through. The angle ε is 0 degrees at the impact and then 180 degrees at the end of the follow-through.

When the angle ε is calculated, the angle γ can be calculated by Equation 28 above, and the solution of A×r×sin γ in Equation 10 above is obtained. The distance X′ can be therefore calculated.

In such a manner, the trajectory of each frame of the ideal form can be transformed by conversion from the distance X to the distance X′.

The controller 11 shifts the position of the trajectory of the ideal form converted as described above so that the position of the trajectory fits to the position of the swinging player in the moving image of the swing of the target: player. This can provide a comparison display between the trajectory of the golf club of the target player in the moving image of the target swing and the trajectory of the ideal form. The position of the trajectory with the ideal form can be shifted in the aforementioned manner.

After correcting the position of the trajectory of the golf club in the moving image of the swing with the ideal form as described above, as shown in FIG. 4, the controller 11 creates display data to display the corrected trajectory of the golf club of the ideal form and the trajectory of the golf club of the target player (step S114). The trajectories of the frames may be displayed by dots or may be displayed by a line connecting the dots. If necessary, the controller 11 then causes the trajectory difference judgment unit 11n to function for diagnosing the trajectory of the golf club of the target player (step S115). The controller 11 then creates display data to display a message corresponding to the results of the diagnosis (step S116). The controller 11 performs a display based on the display data created at the steps S114 and S116 on the display screen of the display unit 13 while displaying the moving image of the check target (step S117). The screen shown in FIG. 30 is thus displayed on the display screen of the display unit 13, for example. In FIG. 30, a corrected trajectory SW3 of the golf club with the ideal form and a trajectory SW4 of the golf club of the target player are displayed.

In the above embodiment, the center of each image of the head of the golf club is plotted as a trajectory. However, it is possible to set a line from the center of the swinging player's body to the head of the golf club and plot the trajectory of this line.

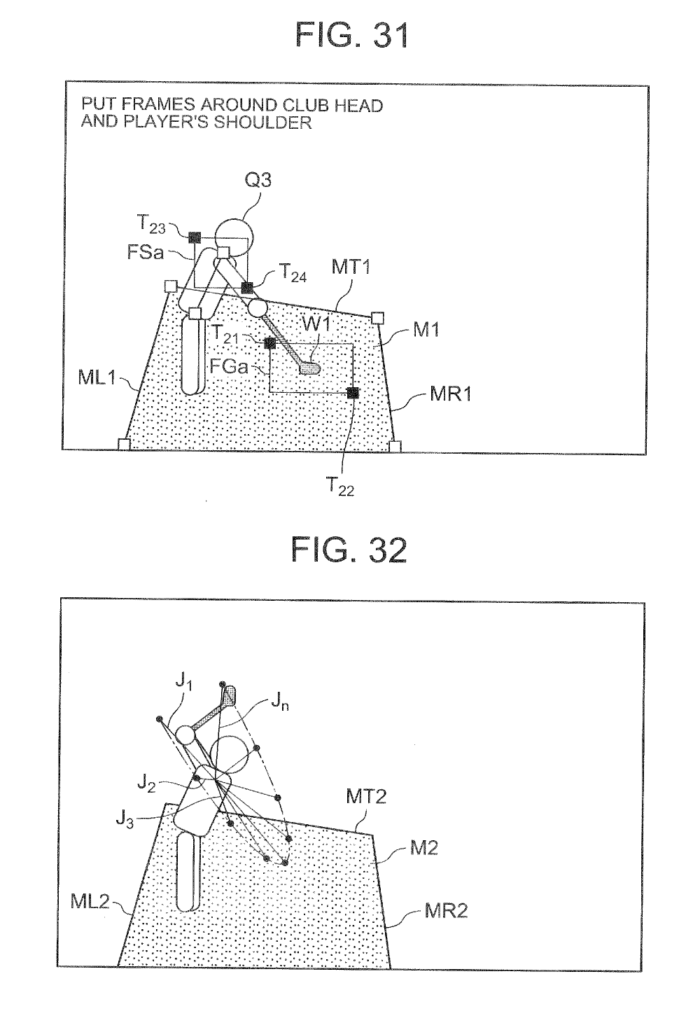

Specifically, for example, in the case of specifying the position of the golf club W1 as described above, as shown in FIG. 31, the position of the swinging player's shoulder as the starting point of a swing of the golf club W1 is specified together with the position of the golf club W1. More specifically, for example, the positions of the pointers T21 to T24, which are displayed on the display screen of the display unit 13, are operated and moved, and the controller 11 defines a rectangular frame FGa based on the positions of the pointers T21 and T22 and defines a rectangular frame FSa based on the positions of the pointers T23 and T24. When the head of the golf club W1 is surrounded by the frame FGa and the swinging player's shoulder is surrounded by the frame FSa, the straight line connecting the centers of the frames FGa and FSa is defined. In the above-described manner, the controller 11 causes the moving target image extraction unit 11r to function for using the images defined by the frames FGa and FSa as the templates and extracting images matching the templates in each of the still images constituting part of the moving image between the follow-through start frame and the follow-through end frame. The controller 11 connects the centers of the extracted, images of each frame with a straight line as a trajectory. For example, as shown in FIG. 32, when the centers of the images matching the templates in each frame are connected, trajectory lines to Jn can be obtained. The trajectory lines J1 to Jn thus obtained are subjected to the correction of position described above, and the results thereof are displayed on the display screen of the display unit 13. This can provide variations in display of the trajectory of a golf club.

As described above, in this embodiment, based on a difference between the first characteristic point in a moving image obtained by capturing under the first capturing situation and the second characteristic point in a moving image obtained by capturing under the second capturing situation, which is different from the first capturing situation, the controller 11 corrects the first trajectory of the first moving target acquired from the moving image obtained under the first capturing situation. The display control unit 11s displays the trajectory corrected by the controller 11. Accordingly, the position of the first trajectory is corrected and displayed according to the capturing angle in the second capturing situation, and even if the first and second capturing situations are different in capturing angle or the like, the position of the first trajectory in the second capturing situation can be accurately understood. This can eliminate the need to capture a moving image again in the second capturing situation for accurate understanding of the position of the first trajectory, for example.

Moreover, in the embodiment, the first setting unit 11a sets at least the two straight lines intersecting at the first characteristic point in the moving image obtained by capturing with each camera 1 to 3 under the first capturing situation. The first trajectory acquisition unit 11c acquires a trajectory of the first moving target (the first, trajectory) from the moving image obtained by capturing with each camera 1 to 3 under the first capturing situation. The second setting unit 11b sets at least two straight lines intersecting at the second characteristic point in the moving image obtained by capturing with each camera 1 to 3 under the second capturing situation, which is different from the first capturing situation. The first capturing angle calculation unit, 11e calculates the capturing angle of each camera 1 to 3 in the process of capturing under the first capturing situation based on the angle formed by the at least two straight lines set by the first setting unit 11a. The second capturing angle calculation unit 11f calculates the capturing angle of the cameras 1 to 3 at the capturing under the second capturing situation based on the angle formed by the at least two straight lines set by the second setting unit 11b. The capturing angle difference calculation unit 11g calculates a difference between the capturing angle calculated by the first capturing angle calculation unit 11e and the capturing angle calculated by the second capturing angle calculation unit 11f. The correction unit 11h corrects the position of the first trajectory acquired by the first trajectory acquisition unit 11c based on the difference in capturing angle calculated by the capturing angle difference calculation unit 11g. The display control unit us displays the first trajectory corrected by the correction unit 11h. Accordingly, the position of the first trajectory is corrected for display according to the capturing angle in the second capturing situation, and even if the capturing angle differs between the first and second capturing situations, the position of the first trajectory in the second capturing situation can be accurately understood.

Furthermore, in this embodiment, the image specifying unit 11p specifies the image of the first moving target. The moving target image extraction unit 11r extracts an image corresponding to the image specified by the image specifying unit 11p in the moving image obtained by capturing with each camera 1 to 3 under the first capturing situation. The first trajectory acquisition unit 11c acquires the first trajectory based on the image extracted by the moving target image extraction unit 11r. This can facilitate extraction of the first trajectory.

In this embodiment, the third setting unit 11i sets a straight line as the third characteristic point in the moving image obtained by capturing with each camera 1 to 3 under the first capturing situation. The fourth setting unit 11j sets a straight line as the fourth characteristic point in the moving image obtained by capturing with each camera 1 to 3 under the second capturing situation. The ratio calculation unit 11k calculates the ratio of the length of the straight line set by the third setting unit 11i to that of the straight line set by the fourth setting unit 11j. The correction unit 11h further corrects the position of the first trajectory acquired by the first trajectory acquisition unit 11c based on the ratio calculated by the ratio calculation unit 11k. Accordingly, the position of the first trajectory can be displayed in a scale of the moving image obtained by capturing under the second capturing situation, for example. The position of the first trajectory in the second capturing situation can be therefore understood more accurately.

Still furthermore, in this embodiment, the position difference calculation unit 11m calculates a difference between the straight line set by the third setting unit 11i and the straight line set by the fourth setting unit 11j. The correction unit 11h further corrects the position of the first trajectory acquired by the first, trajectory acquisition unit 11c based on the difference in position calculated by the position difference calculation unit 11m. The position of the first trajectory can be therefore displayed at the predetermined position of the moving image obtained by capturing under the second capturing situation, for example. Accordingly, the position of the first trajectory in the second capturing situation can be understood more accurately.

Still furthermore, in this embodiment, the first setting unit 11a sets at least two straight lines in each moving image obtained by capturing at plural capturing angles by the cameras 1 to 3 under the first capturing situation. The first trajectory acquisition unit 11c acquires the first trajectory at each captured. The first capturing angle calculation unit 11e calculates the plural capturing angles. The capturing angle difference calculation unit 11g selects one closest to the capturing angle calculated by the second capturing angle calculation unit 11f among the plural capturing angles calculated by the first capturing angle calculation unit 11e and calculates a difference between the selected capturing angle and the capturing angle calculated by the second capturing angle calculation unit 11f. Among the plural first trajectories acquired by the first trajectory acquisition unit 11c, the correction unit 11h corrects the position of the first trajectory corresponding to the capturing angle selected by the capturing angle difference calculation unit 11 based on the difference in capturing angle calculated by the capturing angle difference calculation unit 11g. This can reduce the correction, amount of the position of the first trajectory, thus increasing the accuracy in correction of the position of the first trajectory.

Still furthermore, in this embodiment, the first trajectory acquisition unit 11c sets straight line as the first moving target and acquires the trajectory of the straight line as the first trajectory. This can provide more variations of the trajectory display and therefore provide a wider variety of form analyses, for example.

Still furthermore, in this embodiment, the second trajectory acquisition unit 11d acquires the trajectory of the second moving target from the moving image obtained by capturing with each camera 1 to 3 under the second capturing situation as the second trajectory. The display controller 11s displays the first trajectory corrected by the controller 11 together with the second trajectory acquired by the second trajectory acquisition unit 11d. This can provide a comparison display of the first and second trajectories.

Still furthermore, in this embodiment, the trajectory difference judgment unit 11n judges the difference between the corrected first trajectory and the second trajectory acquired by the second trajectory acquisition unit 11d. The display control unit 11s performs a display according to the results of judgment by the trajectory difference judgment unit 11n. For example, it is therefore possible to show a proper advice about the form specified by the trajectory, thus increasing the convenience.

Still furthermore, in this embodiment, the display control unit us the corrected first trajectory, which corresponds to a still image at a predetermined moment in the moving image acquired by capturing with each camera 1 to 3 under the first capturing situation. This can facilitate the analysis of the trajectory at a certain moment such as a moment that the ball is hit, for example.

In this embodiment, the lines of the tennis court and the mat of the golf range are defined as the first or second characteristic points and are used to calculate the capturing angles. However, the first and second characteristic points can be properly set depending on the capturing target. In the case of capturing a swing of a baseball bat, the batter's box can be defined as a characteristic point. The characteristic point is not limited to the line of the tennis court, the mat of the golf range, or the like but also may be another object, for example, such as a tree or a building. Preferably, the characteristic point is defined in a fixed object.

In this embodiment, as the third and fourth characteristic points, the length of the swinging player's body is defined. However, the third and fourth characteristic points can be properly set depending on the capturing target. For example, the third and fourth characteristic points may be the length of the swinging player's leg, the length of the swinging player from the top to the toe, or the total length of the swinging arm and the tennis racket or golf club.

In this embodiment, the length of the swinging player's body as the third and fourth characteristic points is defined by the pointers but may be defined by using the aforementioned template matching method to track the subject, for example. Specifically, for example, an image around the swinging player's shoulder and an image around the swinging player's waist are set as templates, and the portions matching the template images are extracted from each still image constituting the part of the moving image between the follow-through start frame and the follow-through end frame. The line connecting the centers of the extracted image around the shoulder and the extracted image around the waist is defined as the length of the swinging player's body. The position of the swinging player can be understood accurately even if the swinging player moves.

In this embodiment, the various data to acquire the trajectory of the moving target is registered by reading the stored moving image data of the check target which is obtained by capturing under the second capturing situation but may be registered using real-time moving image obtained by capturing under the second capturing situation.

In this embodiment, the various data to acquire the trajectory of the moving target is registered through input, by the user by using the moving image data of the ideal form and the moving image data of the check target. However, the various data may be automatically registered through image recognition.

In this embodiment, the trajectory of the moving target of the ideal form and the trajectory of the moving target of the check target are compared and displayed together with the moving image of the swing of the target player on the display unit 13. However, it is possible to display only the trajectory of the moving target of the ideal form together with the moving image of the swing of the target player.

In this embodiment, the swing of the ideal form is captured in the first capturing situation while the swing of the target player is captured in the second capturing situation. However, the swing of the target player may be captured in the first capturing situation while the swing of the ideal form is captured in the second capturing situation.

In this embodiment, the trajectory element of each frame is obtained by extracting the image matching the template image. However, the trajectory element of each frame may be manually defined by operations of the input unit 12 or the like.

In this embodiment, the swing of the ideal form is captured in the first capturing situation by each camera 1 to 3, and the moving image of the swing of the ideal form is used to acquire the trajectory. However, the image data of the moving image of the swing with the ideal form may be acquired through a medium or a communication means instead of capturing with the cameras 1 to 3.

In this embodiment, various types of image data of the moving image of the swing of the ideal form are acquired, and the user selects image data for display of the trajectory. However, the number of types of image data of the moving image of the swing with the ideal form may be one.

In this embodiment, the position of the trajectory is corrected by the ratio calculation unit 11k and the position difference calculation unit 11m. The position correction by these function units may not be carried out.

The embodiment and modification of the present invention are described, but the scope of the present invention is not limited to the above-described embodiment and modification and includes the claims and equivalents thereof.

What is claimed is:

1. An image processing apparatus, comprising:
a moving image acquisition unit which acquires a moving image captured under a first capturing situation;
a trajectory correction unit which corrects a trajectory of a moving object in the moving image acquired by the moving image acquisition unit to fit the trajectory to a second capturing situation, which is different from the first capturing situation; and
a display control unit which causes a display unit to display the trajectory corrected by the trajectory correction unit.

2. The image processing apparatus according to claim 1, wherein the trajectory correction unit corrects the trajectory of the moving object in the moving image captured under the first capturing situation based on a difference between a first characteristic point in the moving image captured under the first capturing situation and a second characteristic point in a moving image captured under the second capturing situation, which is different from the first capturing situation.

3. The image processing apparatus according to claim 1, wherein the first and the second capturing situations include a direction and/or a position in which the moving image of a series of motion of a subject is captured with a capturing unit.

4. The image processing apparatus according to claim 1, wherein the trajectory correction unit includes:
a first trajectory acquisition unit which acquires the trajectory of the moving object from the moving image captured under the first capturing situation;
a first capturing angle calculation unit which calculates a capturing angle of the capturing unit under the first capturing situation;
a second capturing angle calculation unit which calculates a capturing angle of the capturing unit under the second capturing situation;
a capturing angle difference calculation unit which calculates a difference between the capturing angle calculated by the first capturing angle calculation unit and the capturing angle calculated by the second capturing angle calculation unit; and
the correction unit which corrects the trajectory acquired by the first trajectory acquisition unit, based on the difference in capturing angle calculated by the capturing angle difference calculation unit, wherein
the display control unit causes the display unit to display the trajectory corrected by the correction unit.

5. The image processing apparatus according to claim 4, wherein the trajectory correction unit includes:
a first setting unit which sets at least two straight lines intersecting at a first characteristic point in the moving image obtained by capturing with the capturing unit under the first capturing situation; and
a second setting unit which sets at least two straight lines intersecting at a second characteristic point in the moving image obtained by capturing with the capturing unit under the second capturing situation, which is different from the first capturing situation, wherein
the first capturing angle calculation unit calculates the capturing angle of the capturing unit under the first capturing situation from an angle formed by the at least two straight lines set by the first setting unit, and
the second capturing angle calculation unit calculates the capturing angle of the capturing unit under the second capturing situation based on an angle formed by the at least two straight lines set by the second setting unit.

6. The image processing apparatus according to claim 2, wherein the trajectory correction unit includes:
an image specifying unit which specifies an image of the moving object; and
an image extraction unit which extracts an image corresponding to the image specified by the image specifying unit from the moving image captured with the capturing unit under the first situation, wherein
the first trajectory acquisition unit acquires the trajectory based on the image extracted by the image extraction unit.

7. The image processing apparatus according to claim 2, wherein the trajectory correction unit includes:
a third setting unit which sets a straight line as a third characteristic point in the moving image captured with the capturing unit under the first capturing situation;
a fourth setting unit which sets a straight line as a fourth characteristic point in the moving image captured with the capturing unit under the second capturing situation; and
a ratio calculation unit which calculates a ratio of a length of the straight line set by the third setting unit to a length of the straight line set by the fourth setting unit, wherein
the correction unit further corrects the position of the trajectory acquired by the first trajectory acquisition unit based on the ratio calculated by the ratio calculation unit.

8. The image processing apparatus according to claim 7, wherein the trajectory correction unit includes:
a position difference calculation unit which calculates a difference in position between the straight line set by the third setting unit and the straight line set by the fourth setting unit, wherein
the correction unit further corrects the position of the trajectory acquired by the trajectory acquisition unit, based on the difference in position calculated by the position difference calculation unit.

9. The image processing apparatus according to claim 5, wherein
the first setting unit sets at least two straight lines for each moving object in moving images captured with a plurality of capturing angles by the capturing unit under the first capturing situation,
the trajectory acquisition unit acquires the trajectory for each captured;
the first capturing angle calculation unit calculates the plurality of capturing angles, wherein
the capturing angle calculation unit includes:
a selection unit which selects the capturing angle closest to the capturing angle calculated by the second capturing angle calculation unit from the plurality of capturing angles calculated by the first capturing angle calculation unit; and
a difference calculation unit which calculates a difference between the capturing angle selected by the selection unit and the capturing angle calculated by the second capturing angle calculation unit, wherein
the correction unit corrects the position of a trajectory corresponding to the capturing angle selected by the capturing angle difference calculation unit among the plurality of trajectories acquired by the first trajectory acquisition unit, based on the difference in capturing angle calculated by the difference calculation unit.

10. The image processing apparatus according to claim 4, wherein the first trajectory acquisition unit sets a straight line as the moving object, and obtains a trajectory of the straight line as the trajectory.

11. The image processing apparatus according to claim 1, wherein
the trajectory correction unit includes a second trajectory acquisition unit acquiring a trajectory of another moving object different from the moving object from the moving image captured with the capturing unit under the second capturing situation, and
the display control unit causes the display unit to display the trajectory of the another moving object acquired by the second trajectory acquisition unit together with the trajectory corrected by the trajectory correction unit.

12. The image processing apparatus according to claim 11, wherein
the trajectory correction unit includes a trajectory difference judgment unit which judges the difference between the corrected trajectory and a second trajectory acquired by the second trajectory acquisition unit, and
the display control unit causes the display unit to display according to the result of judgment by the trajectory difference judgment unit.

13. The image processing apparatus according to claim 1, wherein the display control unit causes the display unit to display the corrected trajectory unit corresponding to a still image at a predetermined time in the moving image captured with the capturing unit under the first capturing situation.

14. An image processing method using an image processing apparatus, comprising:
a moving image acquisition step of acquiring a moving image captured under a first capturing situation;
a trajectory correction step of correcting a trajectory of a moving object in the moving image acquired by the moving image acquisition step to fit the trajectory to a second capturing situation, which is different from the first capturing situation; and
a display control step of displaying the trajectory corrected by the trajectory correction step.

15. A recording medium storing computer readable programs which make a computer to function as:
a moving image acquisition unit which acquires a moving image captured under a first capturing situation;
a trajectory correction unit which corrects a trajectory of a moving object in the moving image acquired by the moving image acquisition unit to fit the trajectory to a second capturing situation, which is different from the first capturing situation; and
a display control unit which causes a display unit to display the trajectory corrected by the trajectory correction unit.
